(19) United States
(12) Patent Application Publication
(10) Pub. No.: US 2017/0032434 A1
(43) Pub. Date: Feb. 2, 2017

(54) METHOD AND SYSTEMS RELATING TO ELECTRONIC MULTI-DOMAIN PUBLISHING

(71) Applicant: ZINATION INC., OTTAWA (CA)

(72) Inventors: DAVID KER, OTTAWA (CA); FADHEL BENSLAMA, GATINEAU (CA); ERIC DUMONT, GATINEAU (CA)

(21) Appl. No.: 15/302,801

(22) PCT Filed: Apr. 7, 2015
(86) PCT No.: PCT/CA2015/000230

§ 371 Date: Oct. 7, 2016

Related U.S. Application Data
(60) Provisional application No. 61/976,169, filed on Apr. 7, 2014.

(51) Int. Cl. G06Q 30/06; G06F 17/21; G06F 3/0484; G06F 17/30; G06F 3/0482

(52) U.S. Cl. CPC G06Q 30/0601; G06F 17/3089; G06F 17/30867; G06F 17/30884; G06F 17/30873; G06F 3/0482; G06F 3/04847; G06F 17/211

(57) ABSTRACT

A computer system for the assisted creation of online interactive published content, the computer system including an input unit for obtaining content from a plurality of sources, a unit for obtaining ZineT™ filters from a database and representing the designs to a user, allowing the user to select from the Zine™ filter unit or automatically selecting the Zine filter based on multiple parameters and applying the Zine™ filter to the source content resulting in the content being published online by the user. The resulting online publication is in a format that can be displayed on a desktop or mobile device as a simple HTML pages or an interactive digital online magazine.

### CROSS-REFERENCE TO RELATED APPLICATIONS

This patent application claims the benefit of Patent Cooperation Treaty application PCT/CA2015/000230 filed Apr. 7, 2015 entitled “Methods and Systems Relating to Electronic Multi-Domain Publishing” which itself claims priority from U.S. Provisional Patent Application 61/976,169 entitled “Methods and Systems Relating to Electronic Multi-Domain Publishing” filed Apr. 7, 2014 the entire content of which are incorporated herein.

### FIELD OF THE INVENTION

This invention relates to publishing and more particularly to publishing solutions supporting multiple channels and dynamic content.

### BACKGROUND OF THE INVENTION

Publishing represents the process of production and dissemination of literature, music, or information, the activity of making information available to the general public. Traditionally, the term refers to the distribution of printed works such as books, magazines, and newspapers. With the advent of digital information systems and the Internet, the scope of publishing has expanded to include electronic resources, such as the electronic versions of books and periodicals, as well as micropublishing, websites, blogs, video game publishing, etc. similarly, the process of publishing has traditionally included a sequence of stages including the development, acquisition, copy editing, graphic design, production (i.e. printing and its electronic equivalents), and marketing and distribution of newspapers, magazines, books, literary works, musical works, software and other works dealing with information, including the electronic media. Typically, computer generated human-readable documents, for example, exhibit a wide range of forms including those appearing on paper or other “tangible” media and others that are only temporarily displayed on “intangible” media like the display surfaces of screens forming part of a wide variety of portable electronic devices and fixed electronic devices.

Tangible documents range from full-color press-printed high-volume books, magazines, and commercial literature to multiple-color laser-printed medium-volume items to one-of-a-kind black-and-white pages printed on personal computer printers. Intangible documents include web pages that are received by telecommunication from a central source, screen displays that are generated by software running on local networks or individual workstations, and digitally-generated video frames. Today many human-readable documents cross both domains being available as tangible media and intangible media. Similarly, with today's computer software tools it has become easier to create documents that share common content but have different layouts or a common layout but different content. However, whilst the application of layout and/or content may vary, i.e. be fluid, they both have structure. With layout it is defined by regions which have particular associations either to what is placed within them, e.g. an image versus text, or to those around them, e.g. the image box is centrally placed between two text boxes. Content has structure that, for example, defines the order of letters or words, or the grouping of sentences in paragraphs. Increasingly, software products have increased the delineation between content features and layout features leading in many instances to either errors in layout and/or content and conflicts between structure associated with the content and structure associated with the layout. In the majority of instances software products define content and layout within a description file.

Content-centric software, such as Microsoft Word, emphasizes content in the description files and supplements the content with layout features as needed. Layout-centric software, such as Adobe's InDesign, emphasizes layout features, such as placement of content elements on a page, in the document description files. In the former the user creates and manipulates the text largely independently of the layout and then layout features are added to the text either manually by the user or established automatically by program defaults and manipulated by the user to establish the desired look. In the latter the user creates and manipulates layout elements. Content is added to the layout-structured document as needed. In both instances, but especially in the latter, these layout elements have become a variety of templates to simplify the process for the user. The result in either instance, except for documents where the user is not particularly concerned with the final result, is the generation of a document description file with substantial user input and a predetermined visual appearance. In many instances the time spent on formatting and finalizing the document being published exceeds that spent on the content. It would be evident that it would be beneficial to have a publishing system that allows the user to focus onto the content they wish to provide and exploits applying one or more filters to the user determined content in order to format the content for publication.

Today, content providers are also faced with the requirement to provide content on a wide variety of operating environments, such as through a webpage on a laptop computer, on an Internet enabled television, on a smartphone, or on a portable gaming console. This presents various challenges according to the content being provided. For example, an image suitable for use on the general website may be too large for use on mobile devices both in terms of electronic file size and pixel dimensions. Simply scaling the image down may not address the problem as, for example, an image of a football team displaying well on a laptop when scaled down to the size of a thumbnail may be undesirable because relevant details are not recognizable. Accordingly, it is common with today's publishing systems to create different versions of the content each specifically published into a format compatible with the operating environment on which the content is to be provided. However, this means not only creating these multiple versions of content but also managing multiple sets of assets, the elements required for forming each version such as different sized copies of an image included within it, for these different operating environments, significantly increasing the complexity and expense of offering the content. Accordingly, it would be beneficial to provide a means of managing an item of content for delivery and user viewing upon multiple devices and display geometries/formats.

Within the prior art making content available on mobile devices presents specific challenges even when the content is fixed but these challenges become even more complex when the content is updated. Today, a channel format such as Rich Site Summary (known commonly as an RSS feed) may be used to provide content on mobile devices in which the channel format remains constant while the content presented within it changes over time. Such channel formats are generated according to a template, e.g. an image place holder and a text placeholder. Accordingly, it would be beneficial to provide a means for automatically publishing updated content or dynamically established content to a user with flexible format and/or allowing multiple dynamic elements, e.g. RSS feeds, to be consolidated to a single item of content provided to the user.

These above issues are exacerbated by what is now known as multi-channel publishing, where the same content is published, i.e. available, via different channels including for example traditional print, email PDF, Internet browser, wireless handheld devices, and electronic paper. Different channels may include in addition to different physical and electronic media/formats the requirement for different languages which is typically not merely an issue of translating the content but also require a requirement of variations in presentation structure. An extreme case of multi-channel publishing is “one-to-one” publishing wherein content is published for and according to the customized requirements of a single user. In this scenario content from various sources may be collated and formatted according to profiles of specific individuals. It would therefore be beneficial to provide users with a publishing application supporting not only the multiple channels but also the demands of “one-to-one” publishing.

Accordingly with prior art publishing methods even though exploiting software tools these are heavily dependent upon human intervention and control such that the potential for integrating simultaneous streams of diverse content from multiple sources and making complex layout choices is necessarily constrained by these human decision/intervention steps. Hence, what is required to address the limitations within the prior art discussed supra is a publishing platform that can accept content to be published and automatically apply one or more filters to the content with little or no user input, interaction, or intervention. As such embodiments of the invention provide for a publishing platform which dynamically defines and applies one or more layouts in dependence upon the content selected discretely or the content and target publishing channel. Further, such a publishing platform should beneficially allow integration into other applications, such as content generation applications, web browsers etc., as well as allowing other applications to access the publishing platform directly as part of their operations, such as embedded search engines in websites, and content aggregator applications.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to publishing and more particularly to publishing solutions supporting multiple channels and dynamic content.

In accordance with an embodiment of the invention there is provided a method of generating on-demand for a user an item of electronic content, the item of electronic content comprising a plurality of items of content without the selection of a template relating to the plurality of items of electronic content by the user or another user.

In accordance with an embodiment of the invention there is provided a method of generating on-demand for a user an item of electronic content comprising a plurality of items of content selected by the user, wherein the item of electronic content is generated in dependence upon an electronic device associated with the user upon which the user makes the request to receive the item of electronic content.

In accordance with an embodiment of the invention there is provided a method of generating on-demand for a user an item of electronic content comprising a plurality of items of content selected by the user, wherein the item of electronic content is generated in dependence upon the format of the item of electronic content and an electronic device associated with the user upon which the user makes the request to receive the item of electronic content.

In accordance with an embodiment of the invention there is provided a method of generating on-demand for a user an item of electronic content comprising a plurality of items of content selected by the user, wherein each item of electronic content of the plurality of items of electronic content is established by applying a filter of a plurality of filters to a web page selected by the user.

In accordance with an embodiment of the invention there is provided a method of generating on-demand for a user an item of electronic content comprising a plurality of items of content selected by the user, wherein each item of electronic content of the plurality of items of electronic content was initially established by applying a filter of a plurality of filters to a web page selected by the user and subsequently selected as part of an online purchase made by the user.

In accordance with an embodiment of the invention there is provided a method comprising:
establishing an asset table stored within a memory associated with a computer system, each entry in the asset table relating to a digital asset at least one of selected and bookmarked by the user through a user interface presenting data to the user;
accumulating for each digital asset within the asset table a content post, each content post generated by applying a predetermined process to the digital asset;
generating posted electronic content from a plurality of content posts, the plurality of content posts established in dependence upon the entries within the asset table; and
formatting for presentation to the user the posted electronic content.

In accordance with an embodiment of the invention there is provided a method of generating a receipt for an online purchase comprising:
establishing an asset table stored within a memory associated with a computer system, each entry in the asset table relating to an asset purchased by the user as part of an online transaction, each entry in the asset table relating to a purchased asset and comprising a digital asset relating to the purchased asset and selected by the user through a user interface presenting data to the user when adding the purchased asset to a digital cart containing items selected for purchase;
accumulating for each digital asset within the asset table a content post, each content post generated by applying a predetermined process to the digital asset;
generating posted electronic content from a plurality of content posts and data relating to the completed asset purchase, the plurality of content posts established in dependence upon the entries within the asset table; and
formatting for presentation to the user the posted electronic content.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts a network environment within which embodiments of the invention may be employed;

FIG. 2 depicts a wireless portable electronic device supporting communications to a network such as depicted in FIG. 1 and as supporting embodiments of the invention;

FIG. 3 depicts a process flow for creating a brochure with a software application according to the prior art;

FIG. 4A depicts a publishing system configuration according to an embodiment of the invention;

FIG. 4B depicts a publishing system configuration according to an embodiment of the invention;

FIG. 5 depicts a web interface for a user exploiting a publishing system according to an embodiment of the invention with options for generating published content on-demand;

FIG. 6A to 6E depict an exemplary process flow for a user exploiting a publishing system according to an embodiment of the invention for generating published content on-demand;

FIG. 7A to 7D depict an exemplary process flow for a user exploiting a publishing system according to an embodiment of the invention for generating published content on-demand from an RSS feed;

FIG. 8 depicts an exemplary process flow for a user exploiting a publishing system according to an embodiment of the invention for generating published content on-demand via a bookmarklet;

FIGS. 9A and 9B depict webpages for a user a user exploiting a publishing system according to an embodiment of the invention for generating published content on-demand via a widget;

FIG. 10 depicts schematic of a family of Zine™ products/services/features exploiting options available to a user exploiting a Zine™ software system and/or software application;

FIG. 11 depicts the concept of content and presentation domains for a publishing system according to an embodiment of the invention for generating published content on-demand;

FIG. 12 depicts the concept of generating final content from multiple content blocks for a publishing system according to an embodiment of the invention for generating published content on-demand;

FIGS. 13A and 13B depict the application of the concept depicted in respect of FIG. 12 for a publishing system according to an embodiment of the invention generating published content on-demand to different electronic devices;

FIG. 14 depicts an exemplary process flow for a dynamic filtering process for a publishing system according to an embodiment of the invention for generating published content on-demand;

FIG. 15 depicts the application of the dynamic filtering process described in respect of FIG. 14 to presenting content upon an electronic device;

FIG. 16 depicts the application of the dynamic filtering process described in respect of FIG. 14 to presenting content via different media channels and upon different electronic devices;

FIGS. 17A to 17D depict the application of a publishing system according to an embodiment of the invention generating published content on-demand to an online shopping process for users;

FIGS. 18A and 18B depict the application of a publishing system according to an embodiment of the invention generating published content on-demand within a website for a retailer;

FIGS. 19A and 19B depict the application of a publishing system according to an embodiment of the invention generating published content on-demand to an online shopping process for a user across multiple websites;

FIGS. 20A and 20B depict the application of a publishing system according to an embodiment of the invention generating published content on-demand to an online shopping process for a user with the generation of a visual receipt; and

FIGS. 21A and 21B depict the application of a publishing system according to an embodiment of the invention generating published content on-demand to an online shopping process for a user with the generation of a visual receipt.

### DETAILED DESCRIPTION

The present invention is directed to publishing and more particularly to publishing solutions supporting multiple channels and dynamic content.

The ensuing description provides exemplary embodiment(s) only, and is not intended to limit the scope, applicability or configuration of the disclosure. Rather, the ensuing description of the exemplary embodiment(s) will provide those skilled in the art with an enabling description for implementing an exemplary embodiment. It being understood that various changes may be made in the function and arrangement of elements without departing from the spirit and scope as set forth in the appended claims.

A “portable electronic device” (PED) as used herein and throughout this disclosure, refers to a wireless device used for communications and other applications that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, and an electronic reader. A “fixed electronic device” (FED) as used herein and throughout this disclosure, refers to a wireless and/or wired device used for communications and other applications that requires connection to a fixed interface to obtain power. This includes, but is not limited to, a laptop computer, a personal computer, a computer server, a kiosk, a gaming console, a digital set-top box, an analog set-top box, an Internet enabled appliance, an Internet enabled television, and a multimedia player.

An “application” (commonly referred to as an “app”) as used herein may refer to, but is not limited to, a “software application” and an element of a “software suite” as used herein may refer to, but is not limited to, a computer program designed to allow an individual to perform an activity. An application thus differs from an operating system (which runs a computer), a utility (which performs maintenance or general-purpose chores), and a programming tools (with which computer programs are created). Generally, within the following description with respect to embodiments of the invention an application is generally presented in respect of software permanently and/or temporarily installed upon a PED and/or FED for the purposes of presenting a micro-survey to a consumer and/or customer.

A “social network” or “social networking service” as used herein may refer to, but is not limited to, a platform to build social networks or social relations among people who may, for example, share interests, activities, backgrounds, or real-life connections. This includes, but is not limited to, social networks such as U.S. based services such as Facebook, Google+, Tumblr and Twitter; as well as Nexopia, Badoo, Bebo, VKontakte, Delphi, Hi5, Hyves, iWiW, Nasza-Klasa, Soup, Glocals, Skyrock, The Sphere, StudiVZ, Tagged, Tuenti, XING, Orkut, Mxit, Cyworld, Mixi, renren, weibo and Wretch.

“Social media” or “social media services” as used herein may refer to, but is not limited to, a means of interaction among people in which they create, share, and/or exchange information and ideas in virtual communities and networks. This includes, but is not limited to, social media services relating to magazines, Internet forums, weblogs, social blogs, microblogging, wikis, social networks, podcasts, photographs or pictures, video, rating and social bookmarking as well as those exploiting blogging, picture-sharing, video logs, wall-posting, music-sharing, crowdsourcing and voice over IP, to name a few. Social media services may be classified, for example, as collaborative projects (for example, Wikipedia); blogs and microblogs (for example, Twitter™); content communities (for example, YouTube and DailyMotion); social networking sites (for example, Facebook™); virtual game-worlds (e.g., World of Warcraft™); and virtual social worlds (e.g. Second Life™).

An “enterprise” as used herein may refer to, but is not limited to, a provider of a service and/or a product to a user, customer, or consumer. This includes, but is not limited to, a retail outlet, a store, a market, an online marketplace, a manufacturer, an online retailer, a charity, a utility, and a service provider. Such enterprises may be directly owned and controlled by a company or may be owned and operated by a franchisee under the direction and management of a franchiser.

A “service provider” as used herein may refer to, but is not limited to, a third party provider of a service and/or a product to an enterprise. This includes, but is not limited to, a retail outlet, a store, a market, an online marketplace, a manufacturer, an online retailer, a utility, an own brand provider, and a service provider wherein the service and/or product is at least one of marketed, sold, offered, and distributed by the enterprise solely or in addition to the service provider.

A ‘third party’ or “third party provider” as used herein may refer to, but is not limited to, a so-called “arms length” provider of a service and/or a product to an enterprise and/or service provider wherein the consumer and/or customer engages the third party but the actual service and/or product that they are interested in and/or purchase.

A “user” as used herein may refer to, but is not limited to, an enterprise, a service provider, and an individual accessing at least one of publishing software and/or publishing software according to embodiments of the invention from the viewpoint of publishing information.

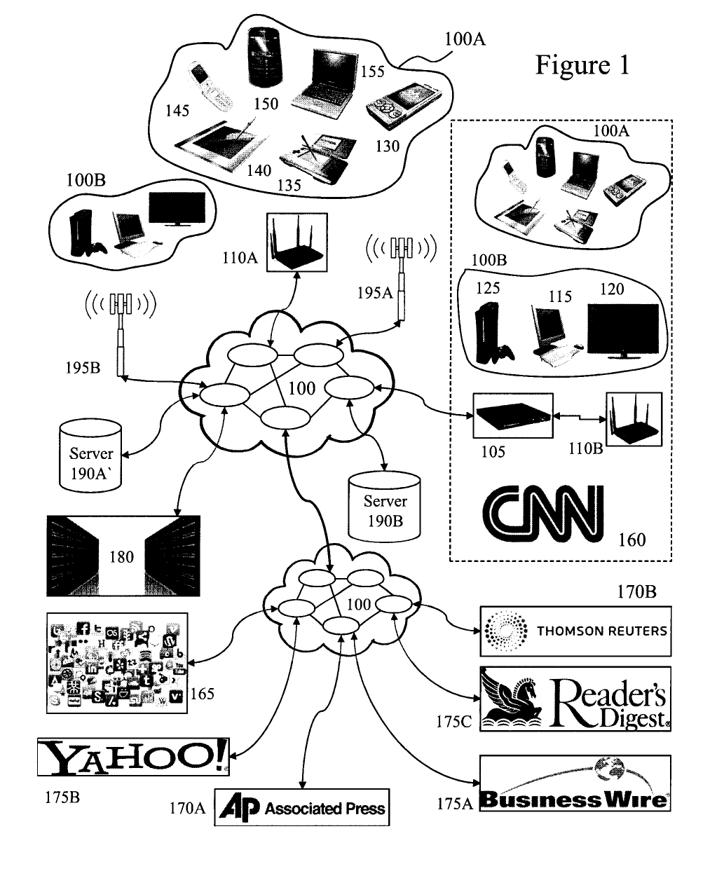

Referring to FIG. 1 there is depicted a network environment 100 within which embodiments of the invention may be employed supporting publishing systems and publishing applications/platforms (PSPAPs) according to embodiments of the invention. Such PSPAPs, for example supporting multiple channels and dynamic content. As shown first and second user groups 100A and 100B respectively interface to a telecommunications network 100. Within the representative telecommunication architecture a remote central exchange 180 communicates with the remainder of a telecommunication service providers network via the network 100 which may include for example long-haul OC-48/OC-192 backbone elements, an OC-48 wide area network (WAN), a Passive Optical Network, and a Wireless Link. The central exchange 180 is connected via the network 100 to local, regional, and international exchanges (not shown for clarity) and therein through network 100 to first and second cellular APs 195A and 195B respectively which provide Wi-Fi cells for first and second user groups 100A and 100B respectively. Also connected to the network 100 are first and second Wi-Fi nodes 110A and 110B, the latter of which being coupled to network 100 via router 105. Second Wi-Fi node 110B is associated with Enterprise 160, e.g. CNN™, within which are other first and second user groups 100A and 100B. Second user group 100B may also be connected to the network 100 via wired interfaces including, but not limited to, DSL, Dial-Up, DOCSIS, Ethernet, G.hn, ISDN, MoCA, PON, and Power line communication (PLC) which may or may not be routed through a router such as router 105.

Within the cell associated with first AP 110A the first group of users 100A may employ a variety of PEDs including for example, laptop computer 155, portable gaming console 135, tablet computer 140, smartphone 150, cellular telephone 145 as well as portable multimedia player 130. Within the cell associated with second AP 110B are the second group of users 100B which may employ a variety of FEDs including for example gaming console 125, personal computer 115 and wireless/Internet enabled television 120 as well as cable modem 105. First and second cellular APs 195A and 195B respectively provide, for example, cellular GSM (Global System for Mobile Communications) telephony services as well as 3G and 4G evolved services with enhanced data transport support. Second cellular AP 195B provides coverage in the exemplary embodiment to first and second user groups 100A and 100B. Alternatively the first and second user groups 100A and 100B may be geographically disparate and access the network 100 through multiple APs, not shown for clarity, distributed geographically by the network operator or operators. First cellular AP 195A as show provides coverage to first user group 100A and environment 170, which comprises second user group 100B as well as first user group 100A. Accordingly, the first and second user groups 100A and 100B may according to their particular communications interfaces communicate to the network 100 through one or more wireless communications standards such as, for example, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, and IMT-2000. It would be evident to one skilled in the art that many portable and fixed electronic devices may support multiple wireless protocols simultaneously, such that for example a user may employ GSM services such as telephony and SMS and Wi-Fi/WiMAX data transmission, VOIP and Internet access. Accordingly portable electronic devices within first user group 100A may form associations either through standards such as IEEE 802.15 and Bluetooth as well in an ad-hoc manner.

Also connected to the network 100 are Social Networks (SOCNETS) 165, first and second service providers 170A and 170B respectively, e.g. Associated Press™ and Thomson Reuters™, and first to third third party providers 175A to 175C respectively, e.g. Business Wire™, Yahoo™, and Reader's Digest, as well as first and second servers 190A and 190B which together with others, not shown for clarity. First and second servers 190A and 190B may host according to embodiments of the inventions multiple services associated with a provider of publishing systems and publishing applications/platforms (PSPAPs); a provider of a SOCNET or Social Media (SOME) exploiting PSPAP features; a provider of a SOCNET and/or SOME not exploiting PSPAP features; a provider of services to PEDS and/or FEDS; a provider of one or more aspects of wired and/or wireless communications; an Enterprise 160 exploiting PSPAP features; license databases; content databases; image databases; content libraries; customer databases; websites; and software applications for download to or access by FEDs and/or PEDs exploiting and/or hosting PSPAP features. First and second primary content servers 190A and 190B may also host for example other Internet services such as a search engine, financial services, third party applications and other Internet based services.

Accordingly, a consumer and/or customer (CONCUS) may exploit a PED and/or FED within an Enterprise 160, for example, and access one of the first or second primary content servers 190A and 190B respectively to perform an operation such as accessing/downloading an application which provides PSPAP features according to embodiments of the invention; execute an application already installed providing PSPAP features; execute a web based application providing PSPAP features; or access content. Similarly, a CONCUS may undertake such actions or others exploiting embodiments of the invention exploiting a PED or FED within first and second user groups 100A and 100B respectively via one of first and second cellular APs 195A and 195B respectively and first Wi-Fi nodes 110A.

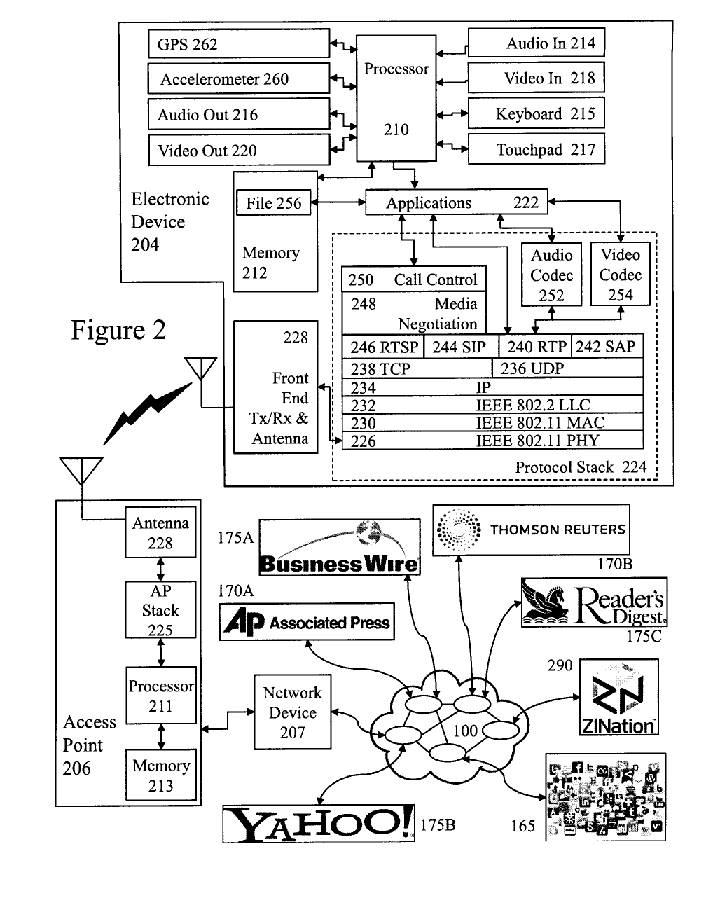

Now referring to FIG. 2 there is depicted an electronic device 204 and network access point 207 supporting PSPAP features according to embodiments of the invention. Electronic device 204 may, for example, be a PED and/or FED and may include additional elements above and beyond those described and depicted. Also depicted within the electronic device 204 is the protocol architecture as part of a simplified functional diagram of a system 200 that includes an electronic device 204, such as a smartphone 155, an access point (AP) 206, such as first AP 110, and one or more network devices 207, such as communication servers, streaming media servers, and routers for example such as first and second servers 190A and 190B respectively. Network devices 207 may be coupled to AP 206 via any combination of networks, wired, wireless and/or optical communication links such as discussed above in respect of FIG. 1 as well as directly as indicated. Network devices 207 are coupled to network 100 and therein Social Networks (SOCNETS) 165, first and second service providers 170A and 170B respectively, first to third third party providers 175A to 175C respectively, and PSPAP provider 290.

The electronic device 204 includes one or more processors 210 and a memory 212 coupled to processor(s) 210. AP 206 also includes one or more processors 211 and a memory 213 coupled to processor(s) 210. A non-exhaustive list of examples for any of processors 210 and 211 includes a central processing unit (CPU), a digital signal processor (DSP), a reduced instruction set computer (RISC), a complex instruction set computer (CISC) and the like. Furthermore, any of processors 210 and 211 may be part of application specific integrated circuits (ASICs) or may be a part of application specific standard products (ASSPs). A non-exhaustive list of examples for memories 212 and 213 includes any combination of the following semiconductor devices such as registers, latches, ROM, EEPROM, flash memory devices, non-volatile random access memory devices (NVRAM), SDRAM, DRAM, double data rate (DDR) memory devices, SRAM, universal serial bus (USB) removable memory, and the like.

Electronic device 204 may include an audio input element 214, for example a microphone, and an audio output element 216, for example, a speaker, coupled to any of processors 210. Electronic device 204 may include a video input element 218, for example, a video camera or camera, and a video output element 220, for example an LCD display, coupled to any of processors 210. Electronic device 204 also includes a keyboard 215 and touchpad 217 which may for example be a physical keyboard and touchpad allowing the user to enter content or select functions within one of more applications 222. Alternatively the keyboard 215 and touchpad 217 may be predetermined regions of a touch sensitive element forming part of the display within the electronic device 204. The one or more applications 222 that are typically stored in memory 212 and are executable by any combination of processors 210. Electronic device 204 also includes accelerometer 260 providing three-dimensional motion input to the process 210 and GPS 262 which provides geographical location information to processor 210.

Electronic device 204 includes a protocol stack 224 and AP 206 includes a communication stack 225. Within system 200 protocol stack 224 is shown as IEEE 802.11 protocol stack but alternatively may exploit other protocol stacks such as an Internet Engineering Task Force (IETF) multimedia protocol stack for example. Likewise AP stack 225 exploits a protocol stack but is not expanded for clarity. Elements of protocol stack 224 and AP stack 225 may be implemented in any combination of software, firmware and/or hardware. Protocol stack 224 includes an IEEE 802.11-compatible PHY module 226 that is coupled to one or more Front-End Tx/Rx & Antenna 228, an IEEE 802.11-compatible MAC module 230 coupled to an IEEE 802.2-compatible LLC module 232. Protocol stack 224 includes a network layer IP module 234, a transport layer User Datagram Protocol (UDP) module 236 and a transport layer Transmission Control Protocol (TCP) module 238.

Protocol stack 224 also includes a session layer Real Time Transport Protocol (RTP) module 240, a Session Announcement Protocol (SAP) module 242, a Session Initiation Protocol (SIP) module 244 and a Real Time Streaming Protocol (RTSP) module 246. Protocol stack 224 includes a presentation layer media negotiation module 248, a call control module 250, one or more audio codecs 252 and one or more video codecs 254. Applications 222 may be able to create maintain and/or terminate communication sessions with any of devices 207 by way of AP 206. Typically, applications 222 may activate any of the SAP, SIP, RTSP, media negotiation and call control modules for that purpose. Typically, information may propagate from the SAP, SIP, RTSP, media negotiation and call control modules to PHY module 226 through TCP module 238, IP module 234, LLC module 232 and MAC module 230.

It would be apparent to one skilled in the art that elements of the electronic device 204 may also be implemented within the AP 206 including but not limited to one or more elements of the protocol stack 224, including for example an IEEE 802.11-compatible PHY module, an IEEE 802.11-compatible MAC module, and an IEEE 802.2-compatible LLC module 232. The AP 206 may additionally include a network layer IP module, a transport layer User Datagram Protocol (UDP) module and a transport layer Transmission Control Protocol (TCP) module as well as a session layer Real Time Transport Protocol (RTP) module, a Session Announcement Protocol (SAP) module, a Session Initiation Protocol (SIP) module and a Real Time Streaming Protocol (RTSP) module, media negotiation module, and a call control module. Portable and fixed electronic devices represented by electronic device 204 may include one or more additional wireless or wired interfaces in addition to the depicted IEEE 802.11 interface which may be selected from the group comprising IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-2000, DSL, Dial-Up, DOCSIS, Ethernet, G.hn, ISDN, MoCA, PON, and Power line communication (PLC).

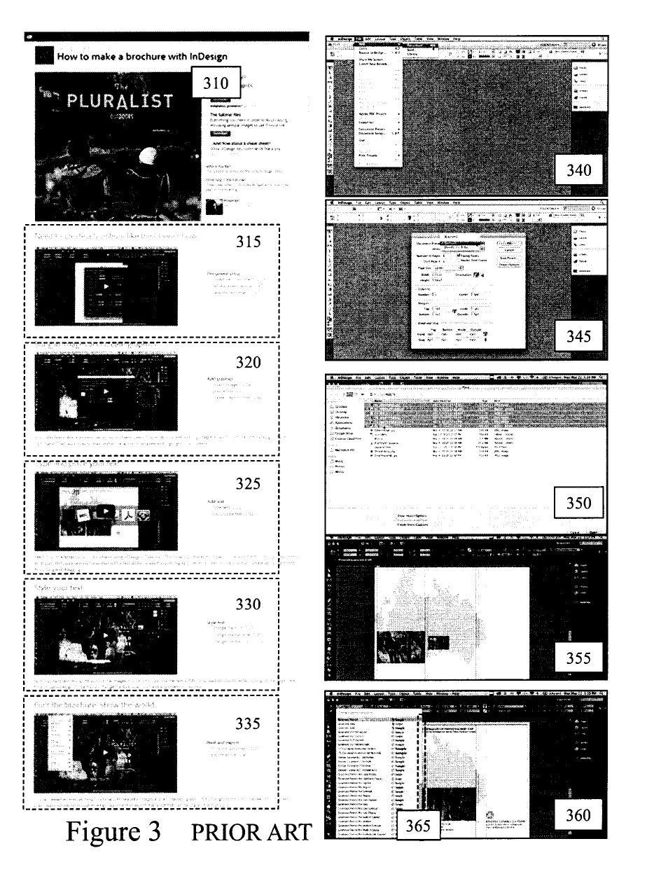

Now referring to FIG. 3 there is depicted a typical prior art sequence for publishing a document, in this instance brochure 310, comprising first to fifth steps 315 to 335 respectively. In first step 315 the user sets up a document via creating a new document (i.e. not using a predetermined or saved template), setting the document layout (e.g. how many pages, start page, page size, margins, whether dimensions are in pixels/inches/centimeters) and then saving the new document. First and second screen images 340 and 345 depict the alternate process where the user selects a “File” drop-down menu and is offered the options of a new custom file layout, setting it to the software defaults, or a stored template, indicated by “David's 7×9” within the list. In second step 320 the user then imports their graphic elements into the document via drop-down menu to stored images in different locations and then can move each image to the right page, adjust its size, adjust its color properties, etc. Such an image selection being depicted in third screen image 350 wherein the user has selected 6 images for insertion into a document wherein these are then individually moved by the user around the page they were inserted to or moves them to another page in the document. Such an operation being shown in fourth screen image 355 wherein the user is depicted having moved and resized one image but has yet to do the same processes to another image within the page they are working upon.

Third step 325 depicts where the user adds text to the document either through a conventional “text box” they add or through a copy-and-paste operation from text entered previously into a text editor or word processing application. The user then adjusts the locations and dimensions of the text boxes to fit the appropriate location they require and the column widths. Also as depicted in fifth screen image 360 the user can adjust the font of the text they have added via a selection on drop down image. As depicted the user is here presented with 29 Garamond fonts which are only part of the options available given the presence of scroll bar 365.

Within the prior art several organizations provide software suites intended to provide the user with a series of software applications such as the page layout and publishing software whose sequence of operations are depicted within FIG. 3. One example is the Adobe Creative Cloud which includes Photoshop™ for image editing and compositing; Illustrator™ for vector graphics generation and illustrations; InDesign™ for page design, layout, and illustrating; Dreamweaver™ website design, application design and coding; AfterEffects™ for visual effects and motion graphics, and Premiere™ for video production and editing. Another is Corel Corporation which offers Illustration, Design and Digital Painting tools such as CorelDRAW, Painter, and PaintIt; Photo Editing and Digital Imaging tools such as PaintShop, AfterShot, and PhotoImpact; Video Editing tools such as VideoStudio and MotionStudio; Office suites such as Corel Office and WordPerfect, together with publishing tools such as Website Creator, eBook Publisher, and Portable Document Format (PDF) tools. Accordingly, the user must to generate published content manually work within at least those software applications providing layout and publishing with potentially multiple others to achieve all the tasks required to publish the item of content.

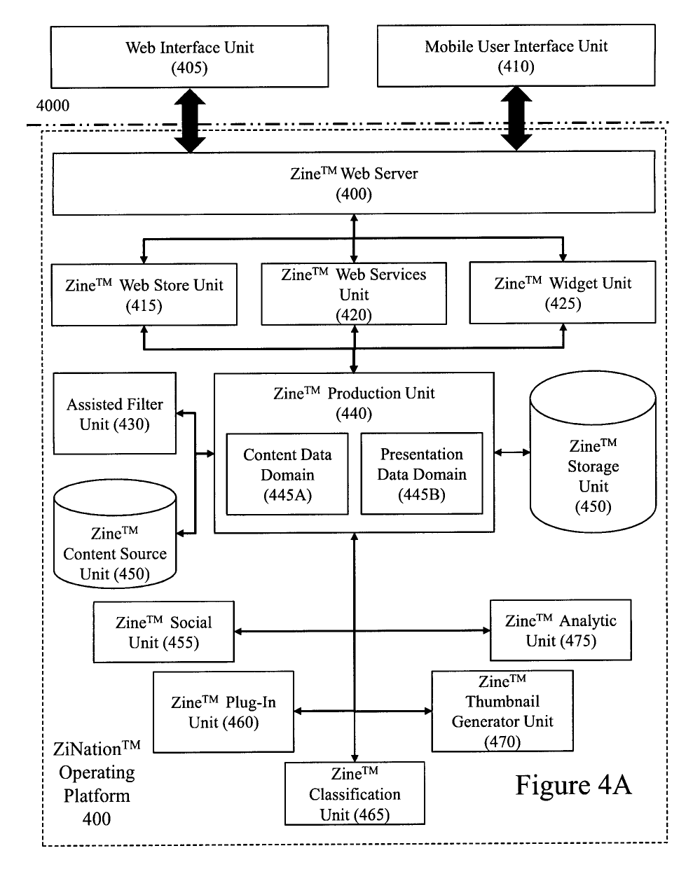

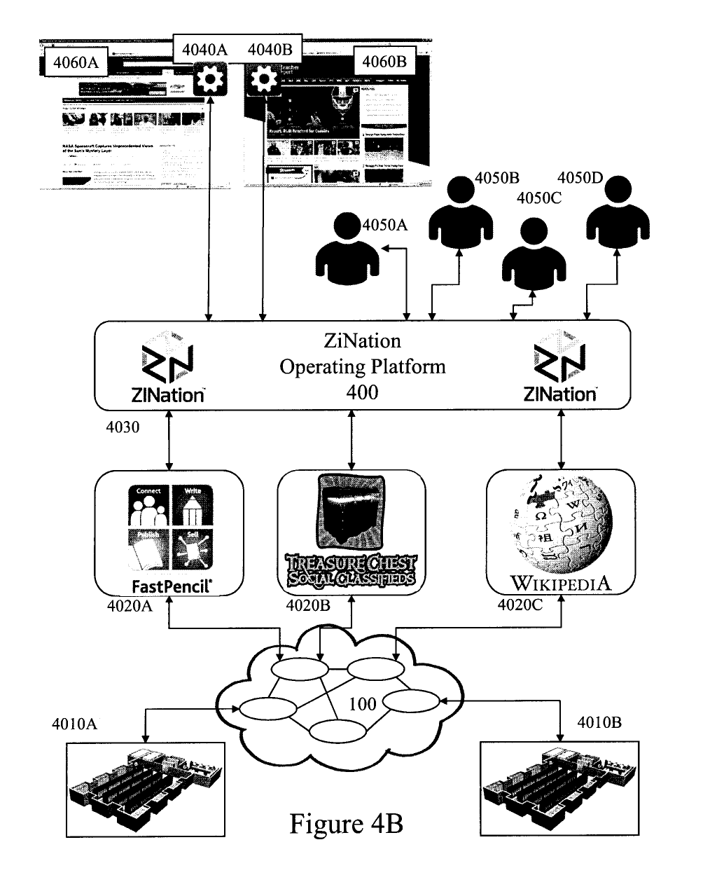

Alternatively, the user may engage an application according to an embodiment of the invention using a platform such as depicted in FIG. 4. The inventors have associated the term “Zine” to such a platform based upon its ability to support multiple channels and provide “one-to-one” publishing which in essence is the minimum circulation. Zine being a term associated most commonly with a small circulation self-published work of original or appropriated texts and images reproduced via photocopier since this is a popular low cost format for distribution. Accordingly, Zine™ within the remainder of this application relates to a software system and/or software application (SSSA) providing all or part of the features of a publishing SSSA according to embodiments of the invention. Zine™ being a trademark of ZiNation™ an operating business of Lassoo the Web Inc.

As depicted a web interface unit 405 and mobile user interface unit 410 provide external interfaces between a Zine™ web server 400 allowing users to access published content and publish content according to embodiments of the invention. Web interface 405 and mobile user interface 410 are depicted as hosted external to a delineation boundary 4000 whilst a ZiNation™ Operating Platform 400 is the other side of the delineation boundary 4000. Interfaced to the Zine™ web server 400 are Zine™ web store unit 415 wherein published content may be accessed by users according to the access privileges they have upon the Zine™ SSSA. Such privileges may, for example, be public in that they can access any published content stored within the Zine™ web store unit 415 that has been tagged as publicly accessible or it may be all public published content plus published content associated with the publisher, company, organization, etc. to which their access privileges are associated. Naturally content published with the Zine™ SSSA may be provided to users through traditional techniques including, but not limited to, attachments to electronic mail, attachments to Simple Message Service (SMS) text messages, hypertext markup accessible links in websites or other content, and PDFs downloadable from a website via a browser.

Zine™ web services unit 420 provides external services such as, for example, provisioning of a web portal, e.g. www.zination.com, through which users can access the Zine™ SSSA to publish content, view published content, etc. Zine™ widget unit 425 provides the required interfaces for third party application to exploit the Zine™ SSSA within their own applications, e.g. a word processor application, an Internet browser, realtor website, etc. Each of these communicates with the Zine™ production unit 440 which maintains two databases, content data domain 445A and presentation data domain 445B. The content data domain 445A maintains associated with each item of published content a list of the content elements it comprises whilst presentation data domain 445B maintains a series of filters, each filter associated with a category of published content and, optionally, a display format. Zine™ production unit 440 is itself interfaced to a Zine™ storage unit 450 which provides storage of the content elements employed in published content, storage of the filters, and storage of fixed format published content (i.e. published content that will not be dynamically adjusted to suit the device from which a user is accessing it.)

Assisted filter unit 430 and Zine content source unit 435 are also interfaced to the Zine™ production unit 440 and provide Zine™ SSSA assisted filtering during publishing from user selected/determined content and database of content sources as in many instances a user may be seeking to publish dynamic content or time varying content and accordingly in addition to storage of the content elements within the Zine™ storage unit 450 it may be appropriate to store the pointer to the information, e.g. RSS feed from British Broadcasting Corporation (http://feeds.bbci.co.uk/news/rss.xml).

Also interfaced to the Zine production unit 440 are:
Zine™ social unit 455 which interfaces to SOCNETs/SOMEs to provide Zine™ functionality such as via Zine™ widget unit 425;
Zine™ plug-in unit 460 which interfaces to external website to provide Zine™ functionality such as via Zine™ widget unit 425;
Zine™ classification unit 465 which allows classification processes to be executed on published Zine™ content;
Zine™ thumbnail generator 470 which generates thumbnail images of published content for provisioning to mobile device users, for example, prior to the provisioning of published content published to them for their particular mobile device; and
Zine™ analytic unit 475 which allows a variety of analytical processes to be executed either upon Zine™ content, Zine™ users, or Zine™ accesses for example.

Now referring to FIG. 4B there is depicted an operating environment for a ZiNation™ Operating Platform 400 as discussed in respect of FIG. 4A. As depicted the ZiNation™ Operating Platform 400 is connected to first and second widgets 4040A and 4040B respectively which are associated with first and second websites 4060A and 4060C respectively and provide access to the ZiNation™ Operating Platform 400 through the first and second websites 4060A and 4060C respectively to publish content that they access and/or generated through either or both of the first and second websites 4060A and 4060C as well as other websites, not shown for clarity. Also shown connected to the ZiNation™ Operating Platform 400 are first to fourth users 4050A to 4050D respectively representing users who may access the ZiNation™ Operating Platform 400 via a PED or FED respectively either to access published content or to publish content.

Also depicted are first to third application/service providers 4020A to 4020C respectively disposed between the ZiNation™ Operating Platform 400 and network 100. These represent application/service providers embedding the ZiNation™ Operating Platform 400 into their website operations such as FastPencil™ (a self-publishing company), Treasure Chest Social Classifieds™ (an online social network enabled classified advertising company), and Wikipedia™ (a free encyclopedia). Also connected to the network 100 are first and second datacenters 4010A and 4010B respectively which may, for example, host the ZiNation™ Operating Platform 400 as well as first to third application/service providers 4020A to 4020C respectively and first and second websites 4060A and 4060C respectively together with other applications, services, data, and content.

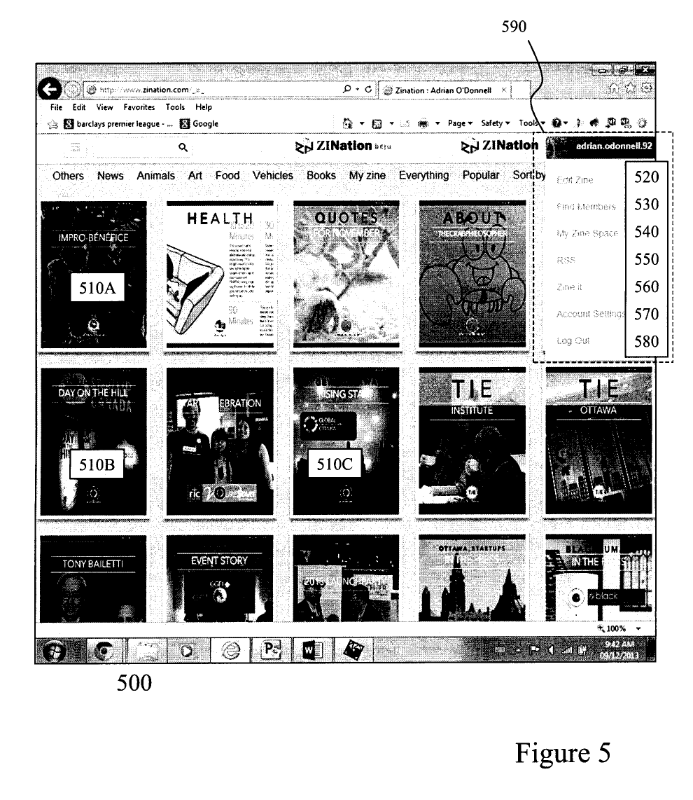

Now referring to FIG. 5 there is depicted an exemplary screen 500 presented to a logged-in user of a Zine™ SSSA such as ZiNation™ Operating Platform 400 in FIGS. 4A and 4B respectively when accessing published content accessible within the Zine™ SSSA. Accordingly, the user is viewing accessible published documents including first to third documents 510A to 510C respectively and has selected the drop-down menu 590 which presents to them a series of options, namely:
Edit Zine 520 wherein the user may edit an existing Zine™ they have published;
Find Members 530 wherein the user may seek a member of a Zine™ community either within the Zine™ SSSA or within a SOCNET′
My Zine Space 540 wherein the user sees their space within the Zine™ SSSA such as what they have published, what they are working on, etc.'
RSS 550 wherein the user may publish a Zine™ from an RSS feed;
Zine™ It! 560 wherein the user may select content to generate a Zine™;
Account Settings 570 wherein the user can change settings relating to their account such as, for example, password, displayed user name, preferences, etc.; and
Log Out 580 wherein the user exits the Zine SSSA.

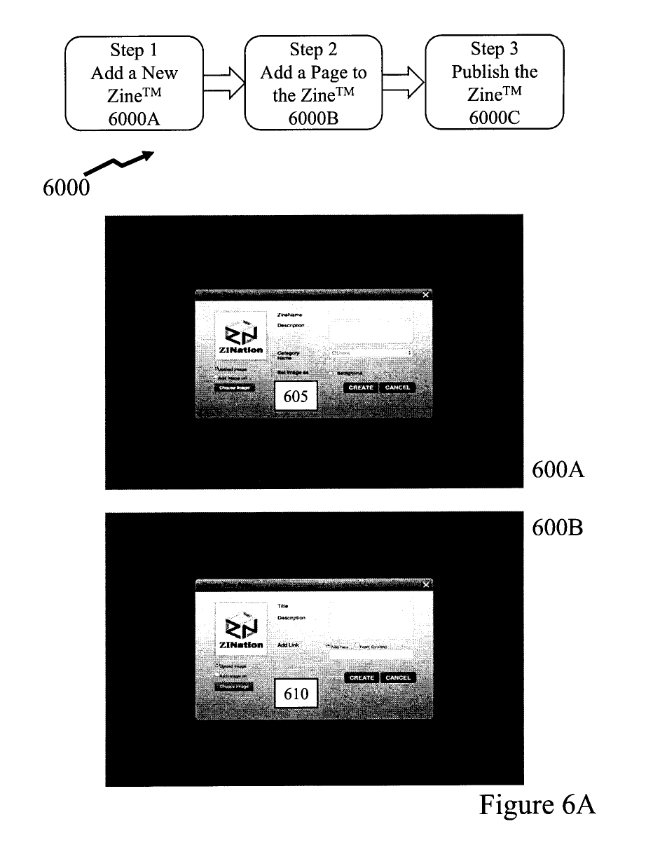

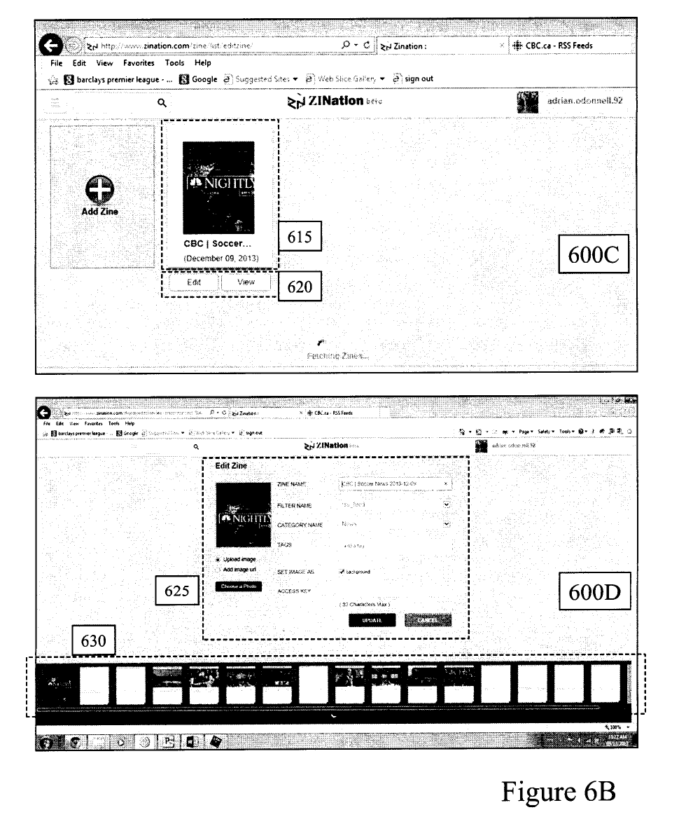

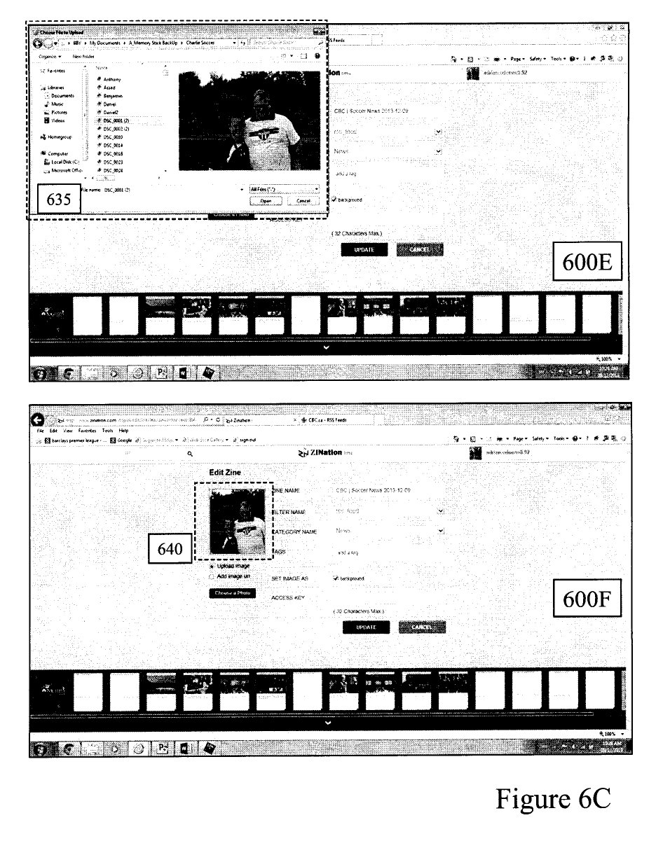

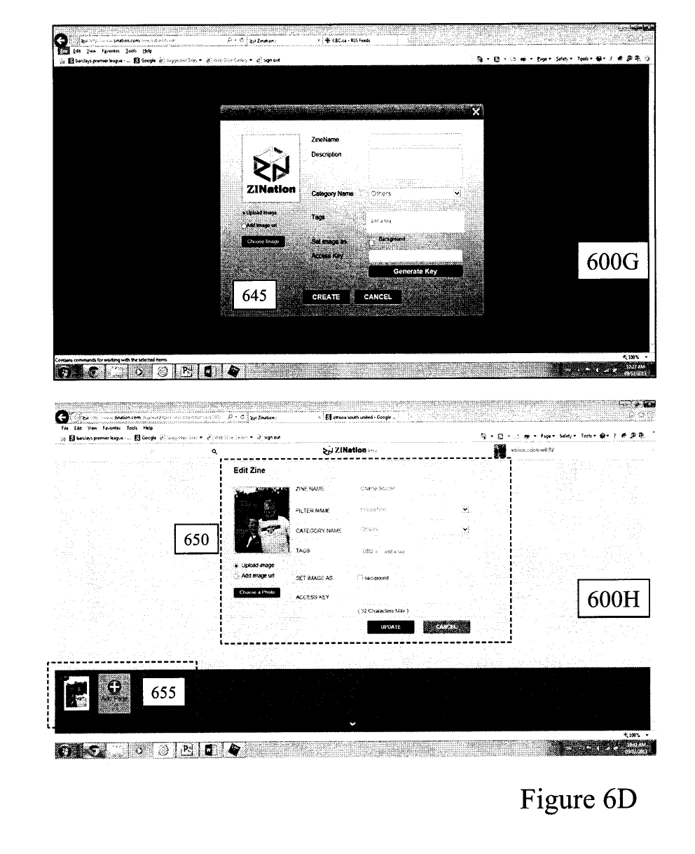

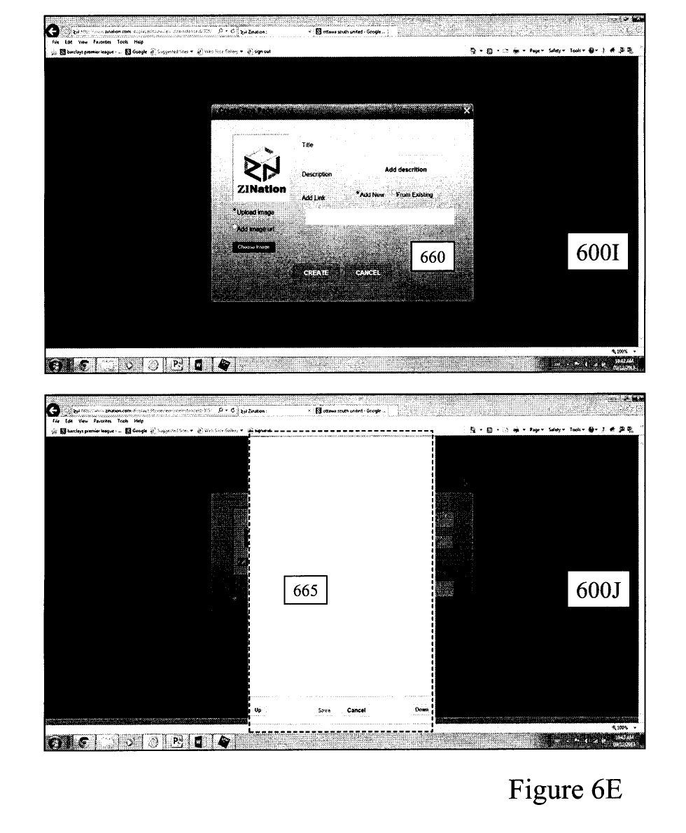

Now referring to FIG. 6A there is depicted an exemplary process flow 6000 relating to generating a Zine™ whilst in FIGS. 6A to 6E there are depicted first to tenth screenshots 600A to 600J. As depicted in process flow 6000 in step 6000A a user decides to add a new Zine™, then in step 6000B the user adds a page to the Zine™ before in step 6000C the Zine™ is published. Accordingly first screenshot 600A depicts first pop-up window 605 wherein the user creates a Zine™ wherein they are prompted to enter the name for the content to be published, a brief description of the Zine™, and a category within which it will be published within the Zine™ community as within this embodiment of the invention all Zine™ documents published are accessible to other users of the Zine™ SSSA. The user can also select an image to upload or select an image URL which will be used to display the Zine™ within the Zine™ community etc. In other embodiments of the invention rather than an image being associated with the published Zine™ an image of the final published Zine™ may be employed whereas in others an enterprise, such as Enterprise 160 for example in FIG. 1, may employ consistent front covers within a particular category as part of corporate branding for example.

In second screenshot 600B the user has opened an existing Zine™ and wishes to add an additional page wherein they are presented with second pop-up 610 wherein the user may similarly add a title for the page to be added, a description of the page, choose whether to add a new page or link a page from another published Zine™ and add an image or image link. Next in third screenshot 600C in FIG. 3C the user is presented with their Zine™ space having selected the My Zine™ Space option in drop-down 590. Accordingly they are presented with a view of their published content, Zine™ 615, and for each item of published content with options 620, e.g. to edit or view the item of published content. If they elect to edit the item of published content then they are presented initially with fourth screenshot 600D comprising page thumbnails 630 and edit zone 625. Within the edit zone 625 the user can modify the Zine™, change the filter applied to the content which is currently shown as “rss_feed”, amend the category, add tags, adjust the image and add an access key to limit access.

If they chose to change the image by uploading rather than via an image Universal Resource Locator (URL) then they are presented with fifth screenshot 600E in FIG. 6C wherein the user can search through storage drives within or connected to the device they are using to access the Zine™ SSSA, including remote network accessible drives, to select an image via search pop-up 635 wherein upon selection the image is uploaded and the Zine edit screen change to that depicted in sixth screenshot 600F wherein the image 640 has been amended to that uploaded. If the user had previously selected to create a Zine™ through selecting Zine™ It! 560 in drop down menu 590. This results in seventh screenshot 600G in FIG. 6D with create pop-up 645 allowing the user to enter data relating to the Zine™ such as, for example, Zine™ name, description, category, tags, and access key as well as selecting an image. In respect of an access key they may elect for the Zine™ SSSA to automatically generate the access key. They are then transitioned to an edit screen as shown by eighth screenshot 600H with edit popup 650 and thumbnail set 655 wherein the front page is shown together with an icon allowing the user to add a new page. Selecting to add a page results ninth screenshot 6001 in FIG. 6E wherein the user can add the information pertaining to the page such as described supra in respect of first and second screenshots 600A and 600B in FIG. 6A for example. This triggers tenth screenshot 600J wherein the user can enter or cut-and-paste text for the description.

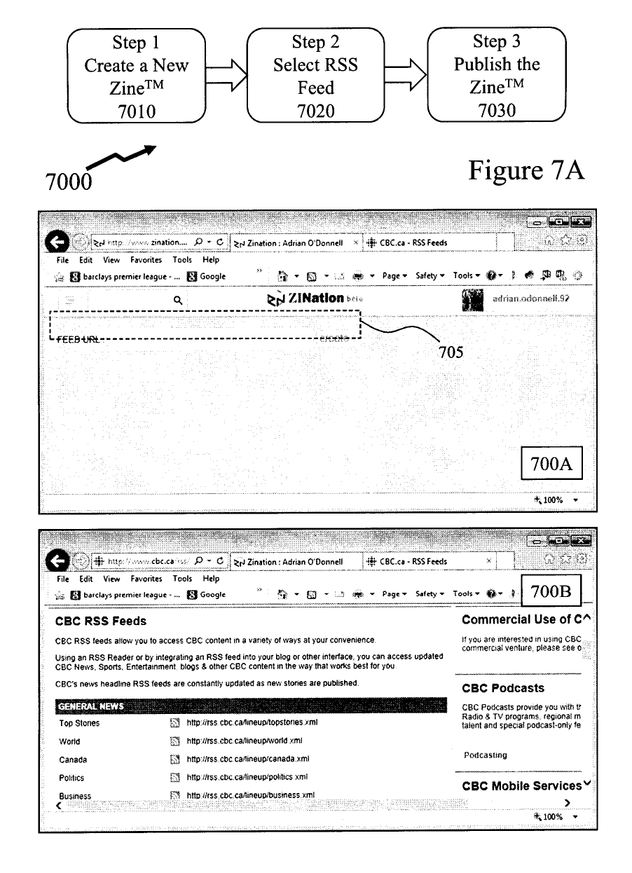

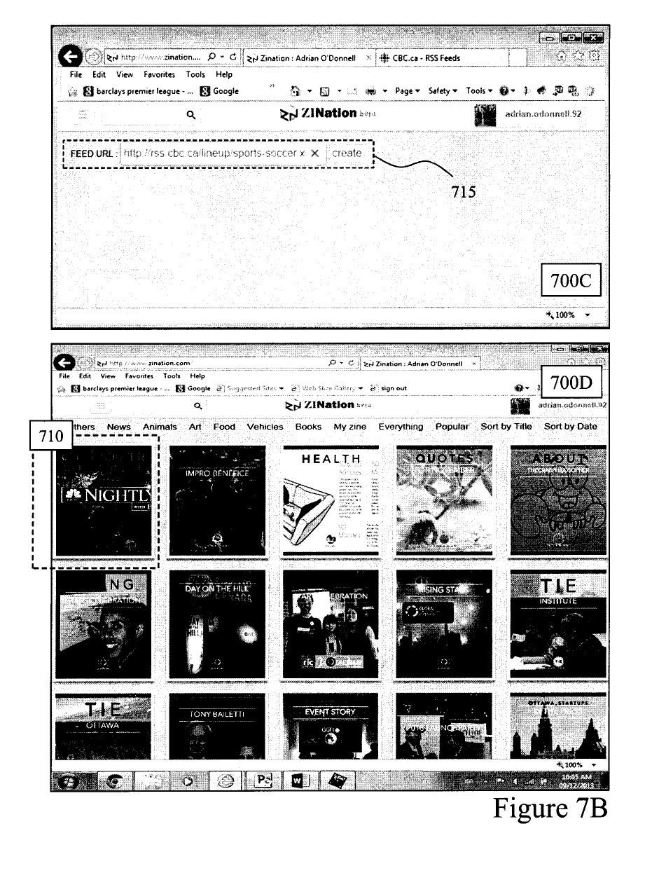

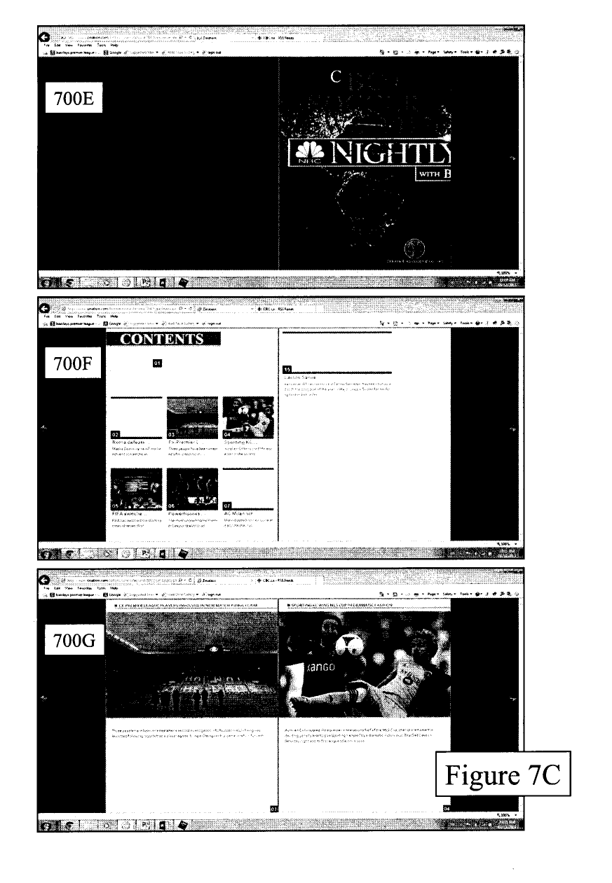

Referring to FIG. 7A there is depicted an exemplary process flow 7000 relating to generating a Zine™ from an RSS feed whilst in FIGS. 7A to 7D there are depicted first to ninth screenshots 700A to 700I. As depicted in process flow 7000 in step 7010 a user decides to add a new Zine™, then in step 7020 the user selects that they wish to create a Zine™ from an RSS feed before in step 7030 the Zine™ is published. Accordingly, the user has previously selected RSS 550 in drop down 590 in FIG. 5 which results in first screenshot 700A wherein a FEED URL box 705 is presented to the user into which they can cut and paste a URL. Subsequently, the user goes to Canadian Broadcasting Corporation (CBC) website and from their webpage of RSS, depicted as second screenshot 700B, copies a URL and then pastes it into FEED URL box 705 as depicted in third screenshot 700C in FIG. 7B with completed URL box 715 whereupon the user selects create resulting in published Zine™ 710 as depicted in fourth screenshot 700D. If the user opens the Zine™ 710 then they are presented with a format comprising a cover, fifth screenshot 700E in FIG. 7C, a contents page, sixth screenshot 700F, and RSS feed pages, seventh screenshot 700G. As evident the contents page and RSS feed pages have been automatically applied by the application of a filter, one of those within the category being applied to a user selected RSS feed with no other intervention or involvement.

If the user moves a cursor to the bottom of any of the cover, contents page, or any of the RSS feed pages then a thumbnail film 720 is presented, as depicted in seventh screenshot 700H in FIG. 7D, allowing the user to view thumbnails of several pages and upon selection of one they are transitioned to that page. Eighth screenshot 7001 depicts an alternate Zine™ generated from a “Wired Business” RSS Feed on Jun. 27, 2013 using the same RSS filter as that employed to generate the Zine™ from the CBC RSS Feeds on soccer on Dec. 9, 2013.

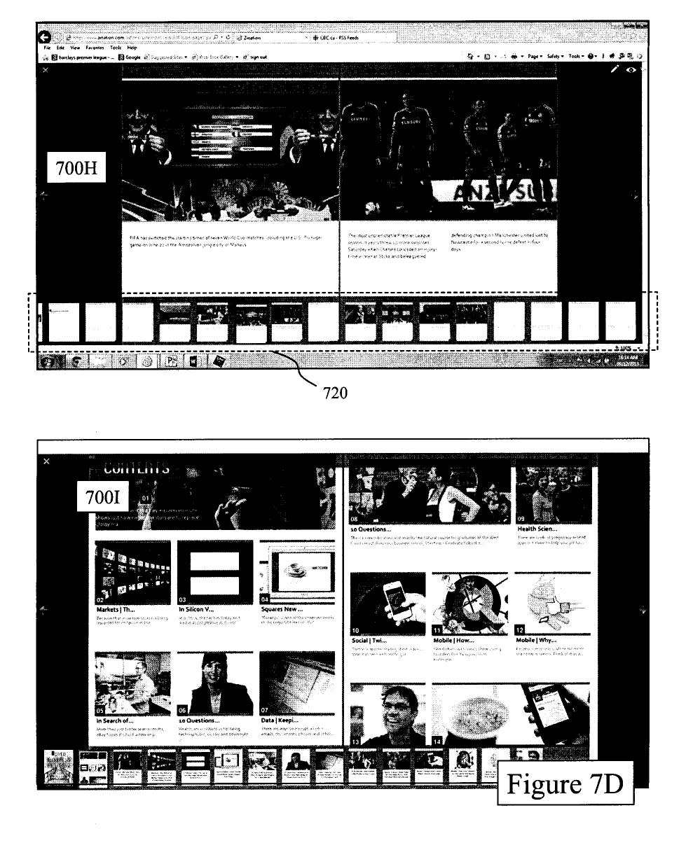

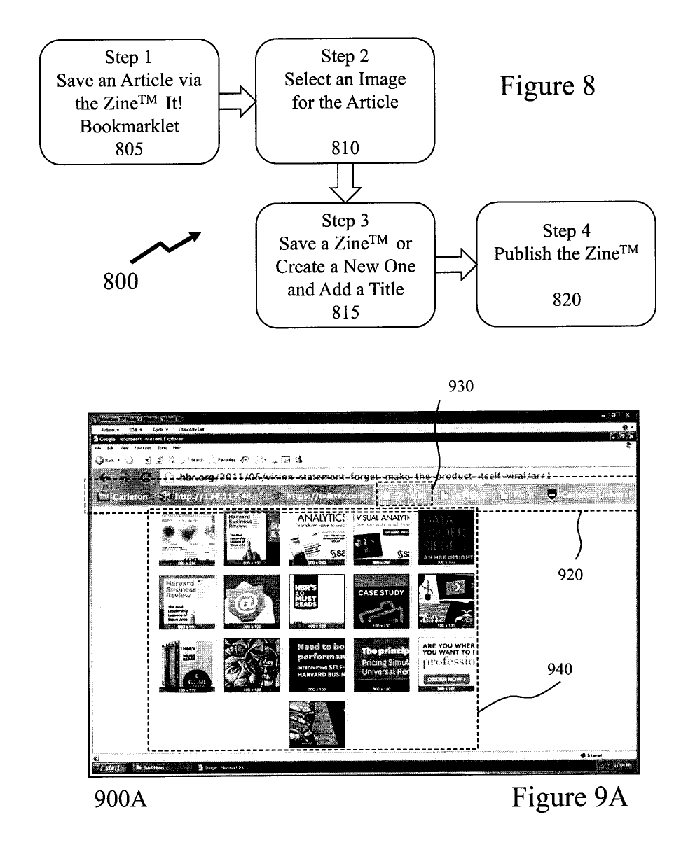

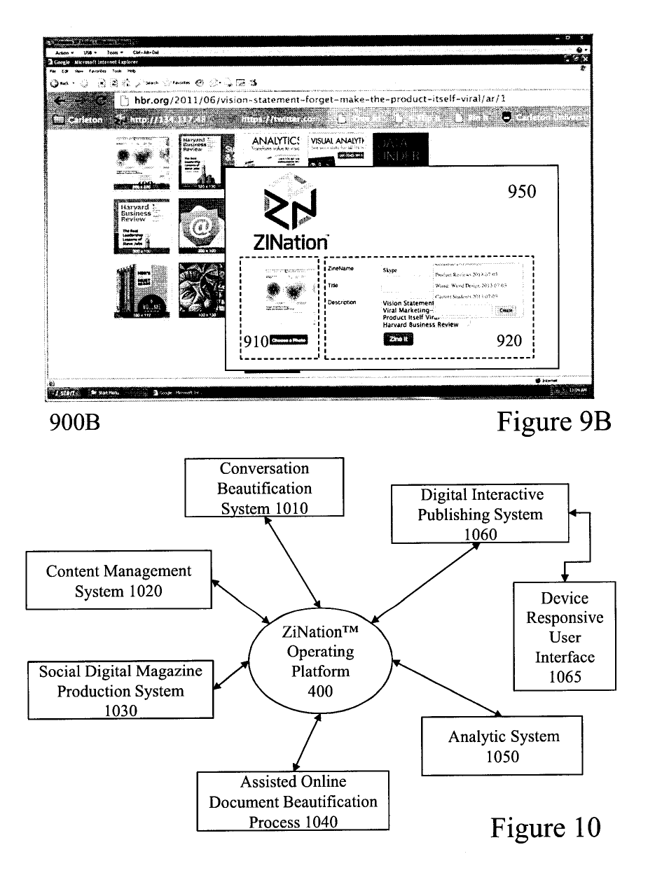

Referring to FIG. 8 there is depicted an exemplary process flow 800 relating to generating a Zine™ using the Zine™ It! 560 option within drop down 590 and as depicted in first and second screenshots 900A and 900B in FIGS. 9A and 9B. As depicted in process flow 800 in step 805 the user decides to save an article via a Zine™, then in step 810 selects an image, wherein they are then prompted in step 820 as to whether they wish to save to an existing Zine™ or create a new Zine™, before in step 820 the Zine™ is published. Selecting the Zine™ It! 560 option provides the user with a widget which can be added to their toolbar, depicted as widget 930 in toolbar 920 in first screenshot 900A in FIG. 9A. Accordingly, the user when presented with a screen 940 may select an image within it, enable the widget 930, resulting in popup 950 in second screenshot 900B in FIG. 9B comprising first region 910 comprising the image together with a first button option for choosing a photo together with second region wherein the user can enter a ZineName, title, and description together with a second button option to Zine™ It!, i.e. create a Zine™.

Referring to FIG. 10 there is depicted a schematic of a family of Zine™ products/services/features exploiting options available to a user exploiting a Zine™ SSSA. A ZiNation™ Operating Platform 400 may provide the hub of such a family of Zine™ products/services/features. These may be default options within the ZiNation™ Operating Platform 400 or they may be optional plugins/features provided to a user with or without credential access or subscription for example. As depicted and discussed with respect to embodiments of the invention the ZiNation™ Operating Platform 400 provides users and other software applications with the ability to acquire content elements and generate published content. Accordingly, a Conversation Beautification System 1010 may be employed to capture, rather than an RSS feed, a message thread between two or more users within a SOCNET or electronic messaging system such that the message thread is parsed and published using a filter selected by a user engaged within the messaging thread, an enterprise hosting the messaging thread, the SOCNET, etc. Accordingly, an enterprise may format messaging to customers using such a Conversation Beautification System 1010 to enhance the user experience and provide a consistent format to all users upon all platforms and devices without intervention. A Content Management System (CMS) 1020 may provide users, enterprises, SOCNETs etc. with a self-contained system wherein content is published via a predetermined filter from a directory or directories. Accordingly, modification to the content elements within the directory or directories results in the Content Management System 1020 determining the change and triggering the generation a new Zine™ using the modified content elements within the directory or directories. As the directory or directories may be network accessible and geographically distributed the Content Management System 1020 allows distributed provisioning of content to a Zine™ initially and its subsequent updating.

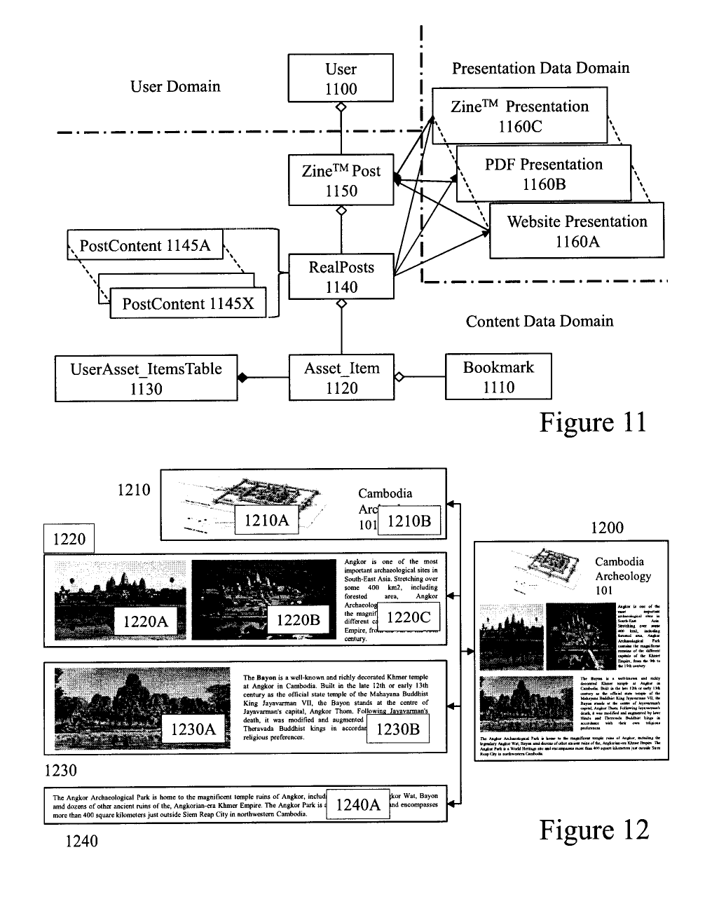

According to embodiments of the invention the CMS 1020 supports the partitioning the Content Data Domain from the Presentation Data Domain, (e.g. Hypertext Markup Language—HTML), creating a clear separation between the two as depicted with Zine™ Production Unit 440 in FIG. 4. The Content Data Domain captures the context of the contents (e.g. real posts 1140 in FIG. 11), gathers media together into one context described as a Zine™ Post (e.g. Zine™ Post 1150). The presentation data domain provide the description of how the content should be presented, e.g. as a Zine™ view, an HTML page view, a native view, a e-publication view, PDF view, etc. Accordingly, the new Content Management System 1020 as described below in respect of FIG. 11 may form part of extensions to the ZiNation™ Operating Platform 400 or it may be integral to the operation of the ZiNation™ Operating Platform 400 as exemplified by Zine™ Production Unit 440 in FIG. 4.

Social Digital Magazine Production System 1030 allows a user or users within a SOCNET or accessing social media, for example, to establish a preferred format for viewing their SOCNET or social media such that a predetermined filter is applied to the captured SOCNET or social media when the user access it allowing it to be distributed upon a wide variety of platforms and devices. For example, a user may wish to view posts in a format similar to that depicted supra in respect of FIGS. 7A to 7D in capturing an RSS feed. Assisted Online Document Beautification Process (AODBP) 1040 provides users with the ability to rapidly establish a document format in dependence upon the content they wish to publish. Accordingly, the user selects the content to be published and a category, e.g. magazine.

The AODPB 1040 allows published content to be resized in many dimensions, the major one being the change in the browsing experience where web pages can be viewed as sequence of pages/content using swiping or user input device actions. The sequential browsing experience is better suited to viewing content. The second major dimension being the removal of obstacles for consuming content on mobile devices as the published content is resized to the device. The third major innovation is the creation of online content compatible with Search Engine and Social Network platforms. Accordingly, published content through the Zine™ Operating Platform works on all devices and allows for online community/SOCNET creation with shared contents in Zine™ format. Accordingly, embodiments of the invention remove the requirements of programming skills, knowledge of multiple content generation, editing, and publication software applications by providing Zine™ formatted content that can be shared within small communities of friends to global distribution, in a manner that also works on all devices, is easy to view and is search engine optimization friendly.

The Assisted Online Document Beautification Process 1040 establishes in dependence upon the category and the content a plurality of filters and generates a set of published documents for the user wherein they can select the published document format that they prefer. If a large number of filters exist then the user may be presented with a sequential sets of images such that within an iteration the user makes one or more selections relating to formats they like and then in the next iteration the user is presented with variants that have common characteristics to the selections they made. According to embodiments of the invention there are presented a system and method that applies and/or proposes a number of filters that an author can use based on a number of parameters, including but not limited to preference settings, keywords, tags, titles, contents, category etc. After application of the filter, the system processes the content and generates published content that works on FEDs and PEDs. The innovations relate to creation protocols, content and presentation associations, and processes for the Zine™ filters. Such Zine™ filter concepts may become generic, potentially a standard, and govern how content is presented to a user, Within embodiments of the invention the Zine™ filter specifications may, for example be Extended Markup Language (XML) based format or a proprietary format which may or may not include other descriptors in other formats such as Hypertext Markup Language (HTML) and Cascading Style Sheets (CSS). Within embodiments of the invention a Zine™ filter is not a template, rather it is a specification that can include a template with additional descriptors to help the publication engine apply one or many templates into contents to generate an output whilst the author of the published content may only specify the content and a category of published content, e.g. magazine, flyer, book, eBook, etc.

Analytic System 1050 allows for analytic processing of aspects of operation of the ZiNation™ Operating Platform 400 or the content, filters, publications, etc. used and/or generated. For example, how frequently are filters applied to blogs rather than RSS feeds or how often are particular RSS feeds accessed, or what image sources are commonly accessed. Device Responsive User Interface (DRUI) 1065 and Digital Interactive Publishing System 1060 act in conjunction with one another to manage the publishing of content and accessibility of content/ZiNation™ Operating Platform 400 to users by exploiting a core concept within the ZiNation™ Operating Platform 400 and embodiments of the invention in that the content is established as a plurality of content elements and then a filter is applied to present the plurality of content elements to the user wherein the filter is selected in dependence upon the plurality of content element solely or the plurality of content element and a characteristic or characteristics of the device the user is viewing the published content upon. Accordingly, in some embodiments of the invention the content is not published to a single format by a single filter but rather to a plurality of formats through a plurality of filters either at an initial publishing stage or on demand.

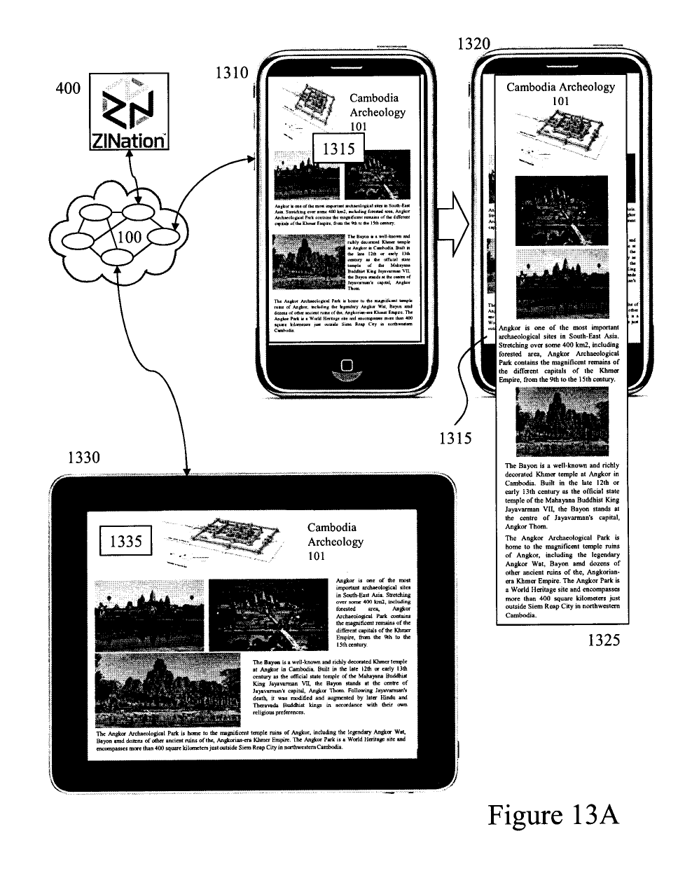

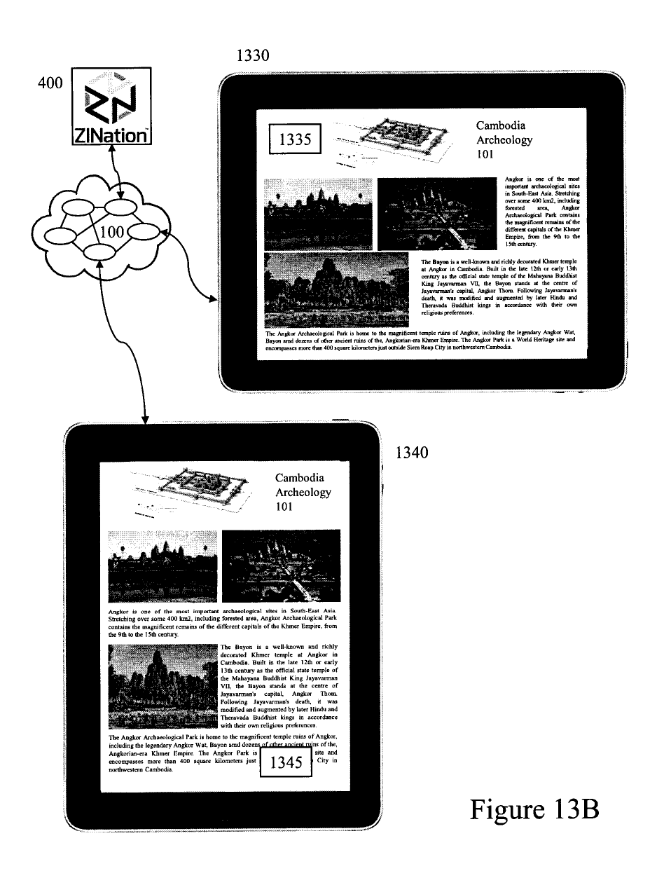

A DRUI 1065 may be responsive in a manner similar in concept to the Responsive Web design (RWD) concept which is aimed at crafting sites to provide an optimal viewing experience, i.e. easy reading and navigation with a minimum of resizing, panning, and scrolling, across a wide range of devices. However, with the RWD concept the webpage design is required to create multiple themes to ensure a website is responsive, i.e. the layout is readable, on all devices. In contrast a DRUI 1065 concept creates only one layout and uses the Zine™ filtering concepts and ZiNation™ Operating Platform to automate the process of creating web responsive sites. According to an embodiments, such as described below in respect of FIGS. 12, 13A and 13B for small display devices the user is presented with a screen capture of a page, i.e. thumbnail, with the option to view and/or read the content responsively on the device. The ZiNation™ Operating Platform can achieve this as it has full knowledge of and access to the content data (e.g. Zine™ Post 1150).

Referring to FIG. 11 there is depicted a flow for a ZiNation™ Operating Platform 400 according to an embodiment of the invention wherein a user 1100 establishes an Zine™ Post 1150 based upon content that the user 1100 has selected, for example using the Zine It! widget, such as described supra in respect of FIGS. 9A and 9B where each item of content selected, or as identified in FIG. 11 bookmarked 1140 becomes an Asset Item 1120 which is stored within a UserAsset_ItemsTable 1130. These are accumulated through a Zine™ process to RealPosts 1140 comprising a series of PostContents 1145A through 1145X respectively. The RealPosts 1140 are then combined to form Zine™ Post 1150 for presentation to the user 1100. The Zine™ Post 1150 being generated by a filter applied to the RealPosts 1140 according to one or more factors including, for example, a format preference of the user 1100, the device the user 1100 is accessing the Zine™ Post 1150, and the intended application of the Zine™ Post 1150. For example, the RealPosts 1140 may be combined by a first filter to provide a Website Presentation 1160A, by a second filter to provide a PDF Presentation 1160B, or by a third filter to provide a Zine™ Presentation 1160C. Accordingly, the first filter may be applied for a web browser access, the second filter for an eBook reader access using a PDF, and the third filter for a smartphone access.

Referring to FIG. 12 there is depicted an exemplary association of PostContent to a RealPost and Zine™. As depicted first to fourth RealPosts 1210 to 1240 respectively are combined to form a PostContent 1200. As depicted first RealPost 1210 comprises first and second PostContent elements 1210A and 1210B, second RealPost 1220 comprises third to fifth PostContent elements 1220A to 1220C, third RealPost 1230 comprises sixth and seventh PostContent elements 1230A and 1230B, and fourth RealPost 1240 comprises eighth PostContent element 1240A.

Now referring to FIG. 13A there is depicted presentation of the PostContent 1200 of FIG. 12 to a user from the ZiNation™ Operating Platform 400 via network 100 to first and second PEDs 1310 and 1320 respectively. Accordingly, the user when viewing, for example, the PostContent 1200 upon first PED 1310, a smartphone, the user is initially presented with first Zine™ 1315. First Zine™ 1315 is a thumbnail generated of the PostContent 1200 formatted to suit the first PED 1310 by combining first to fourth RealPosts 1210 to 1240 with modifications to second RealPost 1220 to maintain a particular image clarity. However, it would be evident that the first to fourth RealPosts 1210 to 1240 may have been combined without modification and presented in portrait format or displayed in landscape format such that the user turns the first PED to view the first Zine™ 1315. If the user then wishes to view the content displayed in first image 1315 then they tap the image wherein the ZiNation™ Operating Platform 400 via network 100 then transmits second Zine™ 1325 to the first PED 1310 which has been formatted according to the characteristics of the first PED 1310 using the first to fourth RealPosts 1210 to 1240 and their associated elements. Accordingly, the second Zine™ 1325 allows the user to view the content and scroll up/down through it as it is presented in a single column format.

Alternatively, the user is accessing the PostContent 1200 on second PED 1330, a tablet computer, the ZiNation™ Operating Platform 400 via network 100 then transmits a third Zine™ 335 to the second PED 1330 which has been formatted according to the characteristics of the second PED 1330 using the first to fourth RealPosts 1210 to 1240 and their associated elements. Subsequently, as depicted in FIG. 13B, the user rotates the second PED 1330 to a portrait orientation, depicted as third PED 1340, from the landscape orientation. Accordingly, the ZiNation™ Operating Platform 400 via network 100 then transmits a fourth Zine™ 1345 to the third PED 1340.

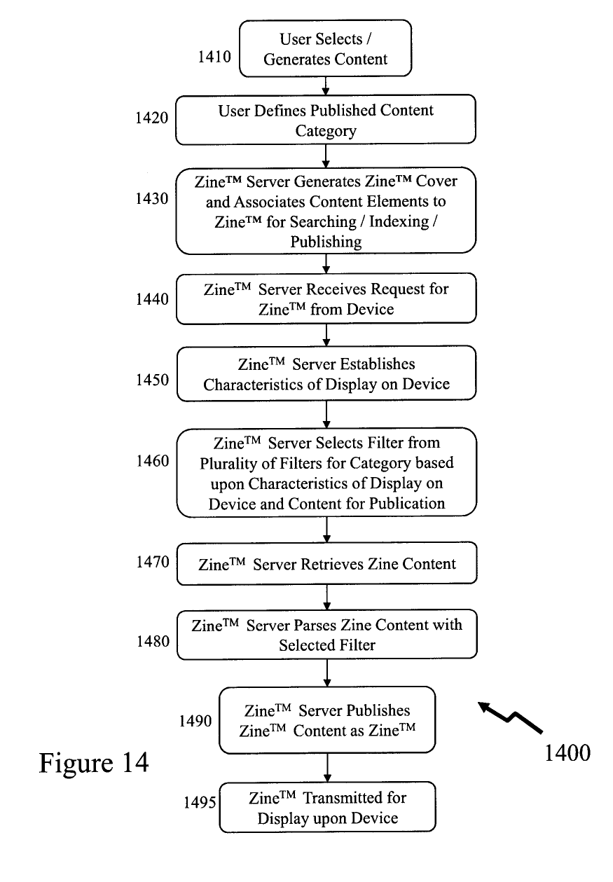

Such a dynamic publishing metholodogy as embodied within embodiments of the invention is described below in respect to exemplary process flow 1400 in FIG. 14. Accordingly, in step 1410 a user selects and/or generates content which they wish to publish and then in step 1420 the user selects a category to define the published content, e.g. newsletter, magazine, brochure, electronic mail, SOCNET, flyer, etc. Then in step 1430 a Zine™ server, such as ZiNation™ Operating Platform 400 as described and depicted in FIG. 4 for example, generates a Zine™ cover for the document, such as depicted in Zine™ 710 as depicted in fourth screenshot 700D in FIG. 7B and associates with the Zine™ the content elements to it for searching/indexing and publishing. Subsequently in step 1440 the Zine™ server receives a request from another user for the Zine™ from the device they are using. Next in step 1450 the Zine™ server establishes the characteristics of the display on the device the user is requesting the Zine™ from.

Subsequently in step 1460 the Zine™ server selects a filter of a plurality of filters associated with the category based upon, at least, the characteristics of the display on the device the user is using and the content to be published. Next in steps 1470 and 1480 the content for the Zine™ is retrieved and parsed by the filter to produce generated Zine™ which is then published in step 1490 and transmitted to the device for display in step 1495.

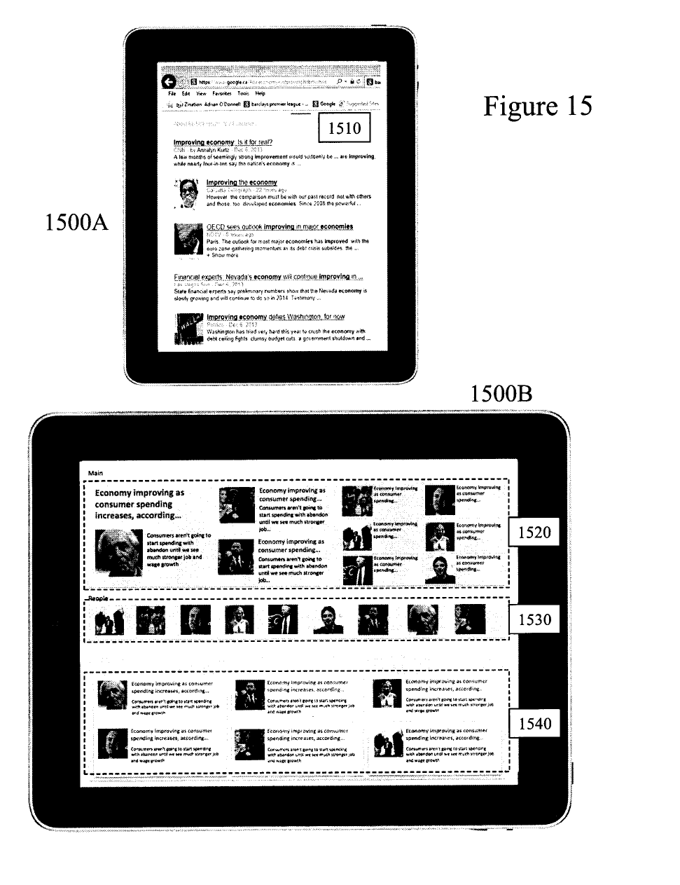

As discussed supra in respect of FIG. 10 a product/service/module forming part of a cluster of services/products in association with ZiNation™ Operating Platform 400 is Conversation Beautification System 1010 which may be employed to capture content and publish it to users in order to enhance the user experience and provide a consistent format to all users upon all platforms and devices without intervention. Referring to FIG. 15 the application of such a Conversation Beautification System 1010 is depicted in respect of an Internet search wherein a search result 1510 is depicted in first image 1500A as presented by the prior art, e.g. Google™, Yahoo!™ and Bing™. However, if the user performing the search has a Zine™ widget and/or plug-in then the search results may be filtered and presented as depicted in second image 1500B wherein the search results were parsed through a Zine™ filter to yield first to third content results 1520 to 1540 respectively. First content result 1520 displays the results in a visually appealing manner, second content result 1530 displays the results based upon the people associated with the items in the search results and third content result 1540 depicts the results based upon linkages within each search result to others in the search. Optionally, the Zine™ filter applied may be a plurality of Zine™ filters wherein the initially “called” Zine™ filter defines three result regions and a Zine™ filter for each region.

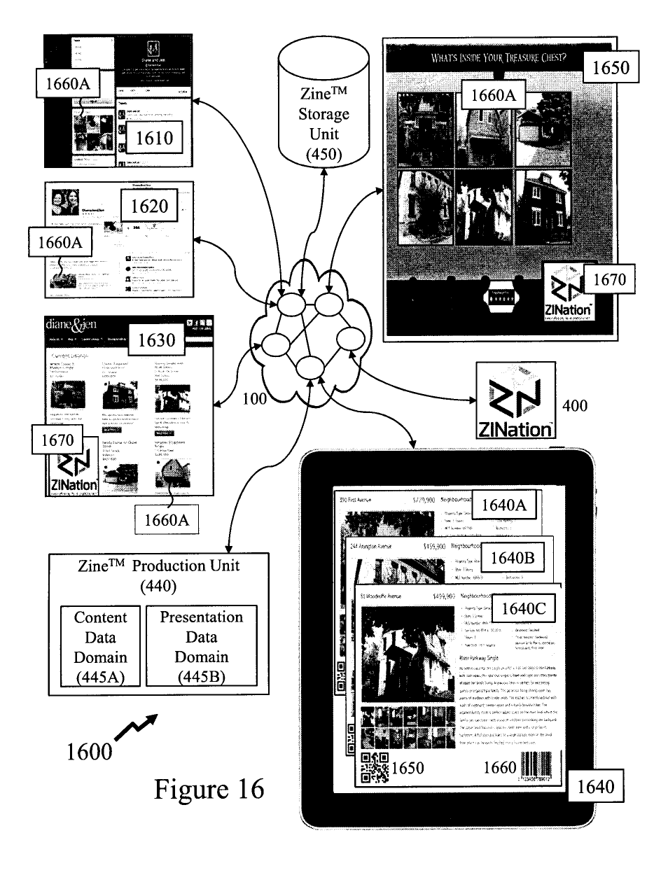

Referring to FIG. 16 there is depicted an application of the ZiNation™ Operating Platform 400 to an enterprise, in this instance a realtor, for application to publishing content. As depicted the ZiNation™ Operating Platform 400 is connected to a network 100 and interfaces with Zine™ Production Unit 440 which retrieves stored content from Zine™ Storage Unit 450. Accordingly, the realtors, Diane & Jen, have established upon the ZiNation™ Operating Platform 400 content relating to their enterprise as well as the properties that they have for sale. This content may be displayed to a user through multiple portals including, for example, Twitter™ 1610, Facebook™ 1620, website 1630, and third party service provider 1640. In each instance the user when clicking upon an image relating to a property 1660A for sale is provided with a first Zine™ generated as described supra in dependence upon the content and display. Alternatively, the user may within some portals of the plurality of portals, e.g. website 1630 and third party service provider 1640 access a ZiNation™ widget 1670 allowing them to tag multiple properties and generate a second Zine™ such as depicted upon tablet computer 1640 comprising first to third pages 1640A to 1640C. In addition to the content within each of first to third pages 1640A to 1640C having common elements to the first Zine™ for each that would be generated from their selection through clicking an image they each contain unique elements, such as QR code 1650 and barcode 1660.

Optionally, the content presented in Twitter™ 1610, Facebook™ 1620, website 1630, and third party service provider 1640 may itself be generated through application of Zine™ filters such that the content of each is displayed to the user in dependence upon the content and the device. This filtered content from the Zine™ filter may itself be modified or the Zine™ filter modified to reflect, for example, user settings within a plug-in or module forming part of the ZiNation™ Operating Platform 400 such as Conversation Beautification System 1010 or Assisted Online Document Beautification Process 1040 for example. Alternatively Conversation Beautification System 1010 or Assisted Online Document Beautification Process 1040 may be individually, in combination, or in combination with other plug-ins/features be employed by the realtor in the generation of the content published to these portals which is initially presented to the user.

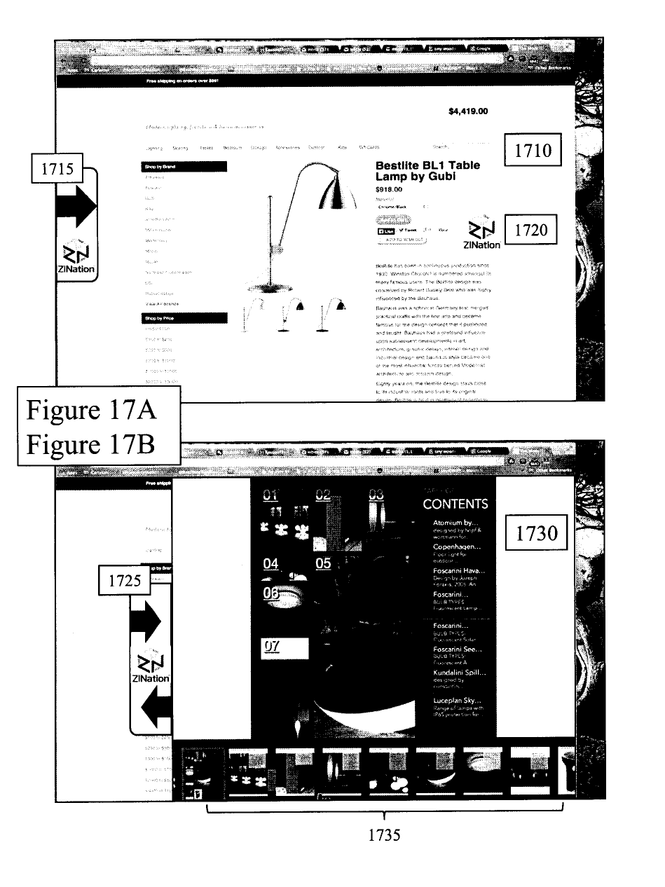

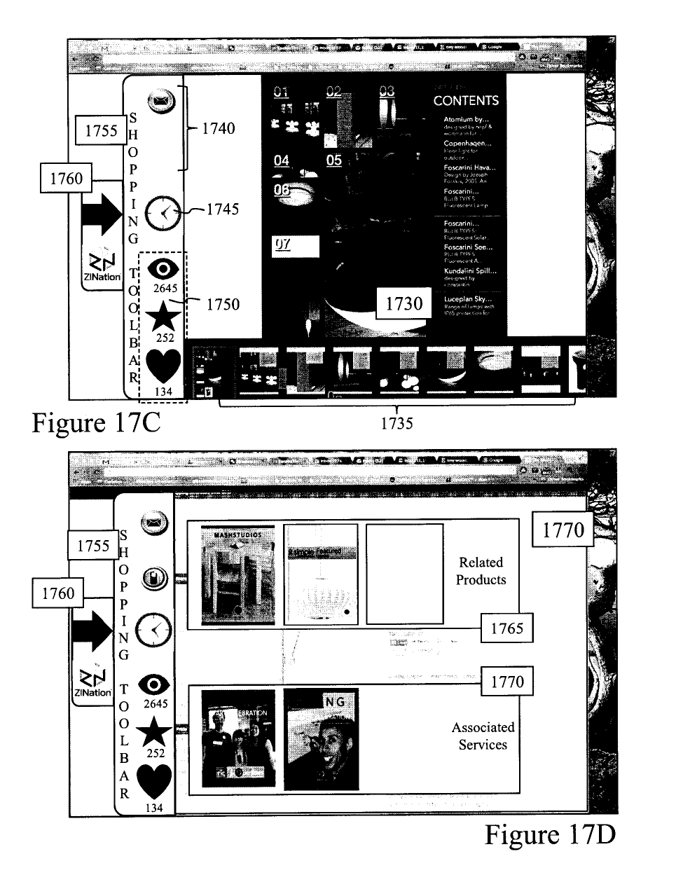

Referring to FIG. 17A there is depicted the application of a publishing system according to an embodiment of the invention generating published content on-demand to an online shopping process for users. As depicted in web screen 1710 a user has accessed the website of a retailer, “The Modem Shop”, and has navigated to view a “Bestlite BL1 Table Lamp” wherein upon the web screen 1710 an icon 1720 and web toolbar 1715 are presented. Selection of the icon 1720 results in the webpage that the user is currently viewing, web screen 1710, being pushed to a ZiNation™ SSSA in execution upon the user's PED/FED through which they are accessing the web screen 1710. Icon 1720 may, for example, be presented in a fixed location upon the displayed web pages, or alternatively, its position may be associated with or determined by the content of the displayed web page(s). If the user selects the web toolbar 1715 then the ZiNation™ SSSA controls the generation of pop-up 1730 as depicted in FIG. 17B.

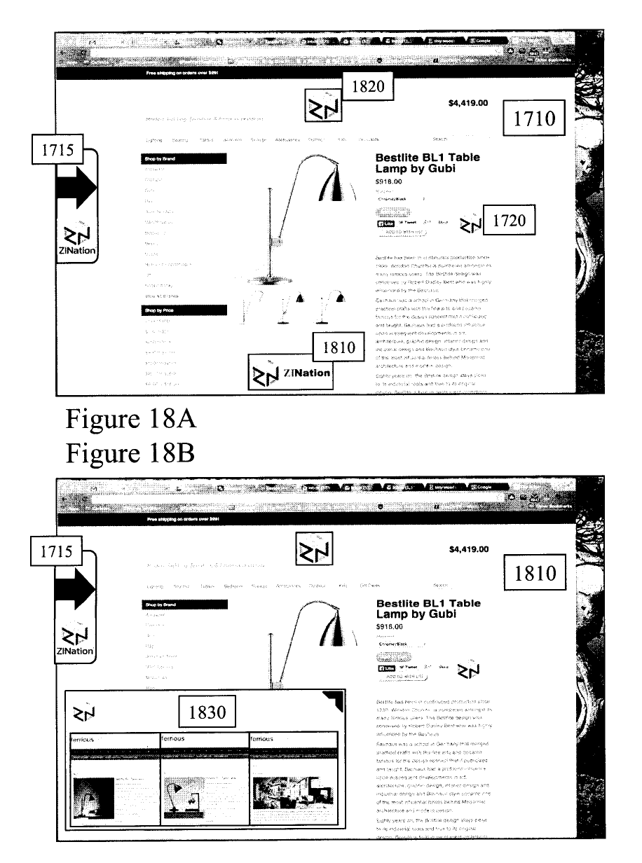

Pop-up 1730 is a Zine™ generated from the web pages selected by the user, wherein the Zine™ may be scrolled sequentially by user actions on the electronic device. In addition to the contents page, the currently displayed Zine™ page, and a thumbnail film 1735 depicting the pages identified by the user. Also depicted is second web toolbar 1725 which allows the user to either close the Zine™ or expand to access further features provided by the ZiNation™ SSSA as depicted and described below in respect of FIGS. 18A and 18B respectively. Pop-up 1730 allows the user to access items of interest that they have previously selected through use of the icon 1720 on different web pages. Rather than having to store a series of bookmarks within their web browser, as known in the prior art, and access them subsequently, the user is able to “flip” through the Zine™ just as if they were a physical or online magazine. However, in accordance with other embodiments of the invention described supra the Zine™ may be stored for subsequent retrieval or it may be forward by the user to their email account, to a friend's email account, or posted to an online service, e.g. a SOCNET/SOME.

If the user selects through second web toolbar 1725 to expand the toolbar then they are presented through the web screen depicted in FIG. 17C comprising pop-up 1730, thumbnail film 1735, third web toolbar 1760 and expanded toolbar 1755. Within expanded toolbar 1755 the user is presented with contact icons 1740, time icon 1745, and social icons 1750. Contact icons 1740 provide the user with the ability to contact the provider of the content of the item displayed on the Zine™. As such certain webpages do not provide for such contacts, e.g. index page. The information relating to the contacts is retrieved from the websites providing the web pages that the user selects the icon 1720 upon. Accordingly, where the user views a Zine™ page they may contact, or retrieve the means to contact, the enterprise associated with the webpage from which the information used to generate the Zine™ page was derived. As described supra in respect of embodiments of the invention the ZiNation™ SSSA a filter may be applied to the web page when the user selects icon 1720 such that only a salient portion of the content is extracted rather than simply a copy of the web page.

Time icon 1745 allows the user to view data associated with when they added the item to the Zine™ as a user may through an embodiment of the invention add using the ZiNation™ SSSA to a previously generated Zine™. For example, a user may generate a wish list, wedding registry, suggestions list, or shopping list using the ZiNation™ SSSA functions and the Zine™ within one or more web sites or web accessible content sources. Alternatively, if the user has added content to the Zine™ over a period of time the time icon 1745 may provide them with the ability to view the Zine™ as it stood at a previous point in time. For example, a user generating a wish list may have added an element and removed another element but has subsequently decided that was an error and wishes to retrieve the removed element wherein they may go to a previous version of the Zine™ to access the element they now wish to recover and add. Social icons 1750 comprises a viewings icon, depicted as an eye, a like icon, depicted as a star, and a recommended icon, depicted as a heart. Selection of these icons provides different functions to the user. For example, as depicted in FIG. 17D a user has selected the recommended icon wherein their web screen changes such that the Zine™ is replaced by screen 1730 wherein the user is presented with first and second windows 1765 and 1770 respectively. First window 1765 depicts Zine™ content for products related to the one that the user was viewing when they selected the recommended icon whilst second window 1770 depicts Zine™ content for service associated with the item the user was viewing. For example, the items within first window 1765 may be those having a high occurrence within other Zine™ content is association with the item the user has been viewing based upon other users such that, for example, if the views the Bestlite BL1 table then they may be shown other lamps with that other users have associated with each Zine™ they generated or perhaps the highest occurring item is a desk. In contrast, those within second window 1770 may, for example, be services associated with the item such that, for example, if the item is a hot water heater they view heating and plumbing service relating Zine™ content of enterprises close to them that may service and/or install the hot water heater. Alternatively, where the user is viewing a manufacturer's website then the user may be presented with references to local stockists in second window 1770.

Referring to FIG. 18A then a user is similarly accessing web screen 1710 but now first and second ZiNation™ SSSA links 1810 and 1820 respectively in addition to the icon 1720 and first web toolbar 1715 as discussed supra in respect of FIGS. 17A through 17D respectively. Selection of first ZiNation™ SSSA link 1810 yields second web screen 1810 wherein pop-up 1830 is presented to the user. Pop-up 1830 is a Zine™ relating to the manufacturer of the Bestlite BL1 table lamp. Alternatively, selection of the second ZiNation™ SSSA link 1820 may trigger a pop-up which presents a Zine™ associated with the enterprise, e.g. The Modern Shop, such as their lighting catalog.

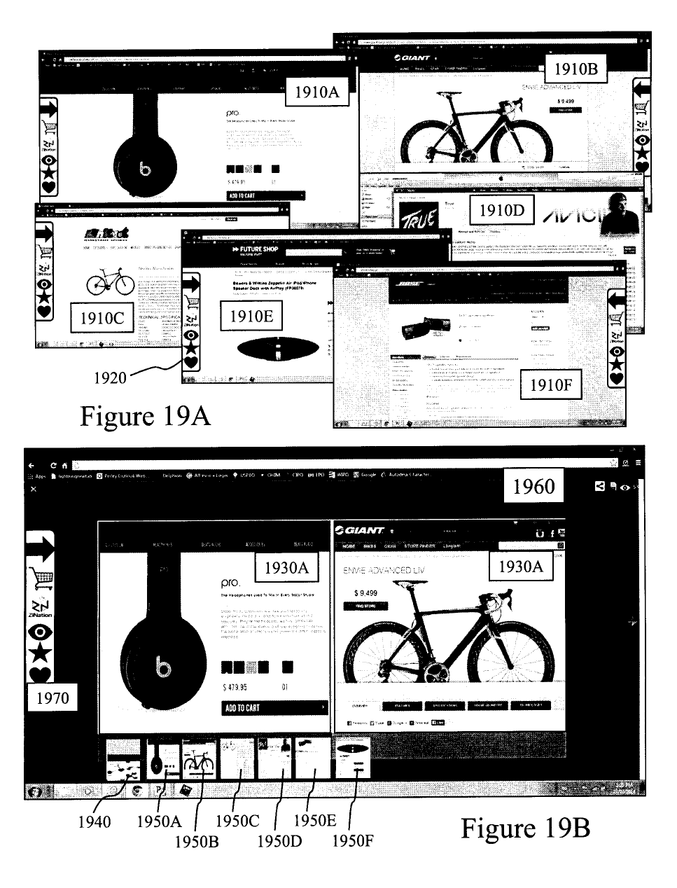

Referring to FIG. 19A there are depicted first to sixth webpages 1910A to 1910F respectively representing webpages which a user has accessed and made selections within exploiting features of a ZiNation™ SSSA such as an icon 1720 or toolbar 1715 as described supra. Accordingly, the use via toolbar 1920 within each of the first to sixth webpages 1910A to 1910F respectively identify content, e.g. via the ZiNation icon within the toolbar 1920. Subsequently, the user may access a Zine™ 1960, as depicted in FIG. 19B, comprising, for example, comprising a cover page 1940 and first to sixth pages 1950A to 1950F respectively representing content the user selected from their activities within first to sixth webpages 1910A to 1910F. Accordingly, as depicted the user is viewing first and second pages 1930A and 1930B respectively, being Beats™ Audio and Giant™ bicycles, derived from first and second webpage 1910A and 1910B. Also depicted in FIG. 19B is toolbar 1970 which contains a purchasing icon, depicted as a shopping trolley, allowing the user to select an item for purchase from the single or multiple Zine™ generated by the user.

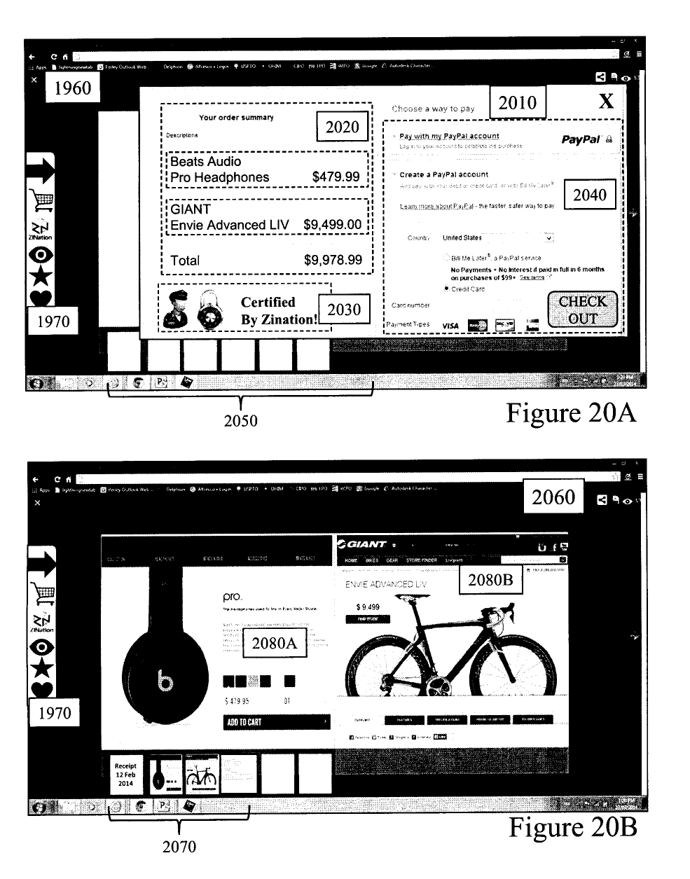

Referring to FIG. 20A the Zine™ 1960 is depicted with thumbnail film 2050 comprising cover page 1940 and first to sixth pages 1950A to 1950F respectively as described supra in respect of FIG. 19B. Also depicted within FIG. 20A is checkout window 2010 comprising a list 2020 of items the user has selected for purchase, a certification window 2030, and a payment window 2040 where the user selects the method of payment and completes the appropriate information. Also within payment window 2040 is a checkout button allowing the user to trigger the purchase. Once the purchase process has been completed the ZiNation™ SSSA generates a new Zine™ 2060 as depicted in FIG. 20B with thumbnail film 2070 and first and second Zine™ pages 2080A and 2080B, representing a pair of Pro headphones by Beats™ and an Elite bicycle by Giant™, together with cover page and electronic payment confirmation information. Accordingly, Zine™ 2060 represents a visual receipt for the user. Many individuals find visual cues superior to simple textual cues. Accordingly, a user faced with finding a receipt may find finding a picture easier than trying to match text printed on a receipt, especially which in many instances the text on the item does not bear a direct relationship to the item they purchased. Additionally, as the Zine™ is stored and accessible online the user will be less likely to lose such a receipt compared to others.

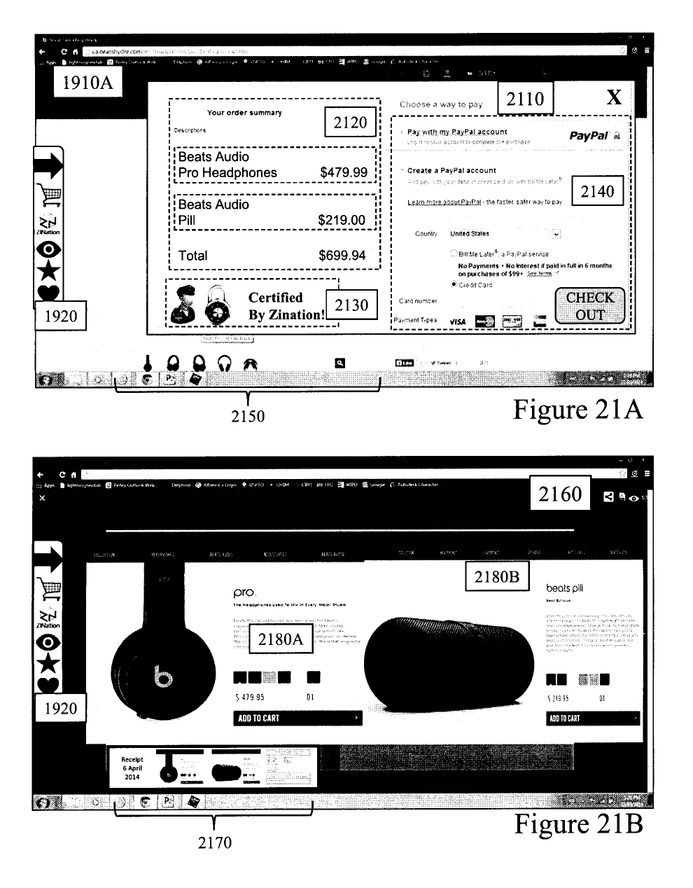

The process flow described and depicted in respect of FIGS. 19A to 20B allows a user to browse multiple sources of content and select items of content from these multiple sources and to generate a Zine™ which can subsequently accessed, distributed, etc. as described supra in respect of embodiments of the invention. Subsequently, using this Zine™ within the ZiNation™ SSSA the user may select one or more items, purchase them, and be provided with a new Zine™ as their receipt. It would be evident that within another embodiment of the invention that a user may make a purchase within a website supporting the ZiNation™ SSSA functionality. Such an embodiment of the invention is depicted with respect to FIGS. 21A and 21B wherein a publishing system according to an embodiment of the invention generates published content on-demand to an online shopping process for a user with the generation of a visual receipt.

Accordingly, referring to FIG. 21A the user has accessed a webpage 1910A, corresponding to first webpage 1910A associated with Beats™ Audio as discussed supra in respect of FIG. 19A, forming part of a website. Within this website the user may identify content, e.g. through the ZiNation icon within the toolbar 1920 such as described supra in respect of FIG. 19A. However, now rather than identifying content from multiple websites they have selected items of content from a single website and then selected a checkout feature of the toolbar 1920, e.g. the shopping trolley icon. This triggers a checkout window 2110 comprising a list 2120 of items the user has selected for purchase, e.g. a pair of Beats™ Audio Pro headphones and a Beats™ Audio pill loudspeaker system. Also present within checkout window 2110 is a certification window 2130, and a payment window 2140 where the user selects the method of payment and completes the appropriate information. Also within payment window 2140 is a checkout button allowing the user to trigger the purchase. Once the purchase process has been completed the ZiNation™ SSSA generates a new Zine™ 2160 as depicted in FIG. 21B with thumbnail film 2170 and first and second Zine™ pages 2180A and 2180B, representing the pair of Beats™ Audio Pro headphones and Beats™ Audio pill loudspeaker system, together with cover page and electronic payment confirmation information. Accordingly, Zine™ 2160 represents a receipt for the user, but now one with a visual record of the items purchased. According to the configuration of the ZiNation™ SSSA the Zine™ may be electronically sent to an email address of user making the purchase. Additionally, the Zine™ may be remotely stored and accessible online to the user through the ZiNation™ SSSA.

Accordingly, the ZiNation™ SSSA according to embodiments of the invention allows a user to select items within a single website, across multiple virtual stores within a website, and across a plurality of websites, for example, for immediate purchase and/or subsequent review themselves or to be sent to friends, family, etc. as well as providing a visual record of purchases made. Accordingly, examples of such activity include, but are not limited to, a user creating a Zine™ for their bridal registry, a user providing family with suggestions for a birthday present, or a user seeking feedback from friends on potential purchase options.

Within an embodiment of the invention not depicted within the preceding Figures a registry variant of the Zine™ may allow a couple to select items for a bridal registry, for example, wherein the published Zine™ then allows those receiving or given access to the Zine™ to make purchases. Within this variant the purchase results not only in the purchaser being given a receipt but the original Zine™ being modified to remove the selected item and the resulting Zine™ therefore shows only the items remaining. This may be pushed to the remaining guests on the distribution list or provided online for access replacing the original Zine™.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method comprising:
generating on-demand for a user an item of electronic content, the item of electronic content comprising a plurality of items of content without the selection of a template relating to the plurality of items of electronic content by the user or another user.

2. The method according to claim 1, wherein
the another user defines only a content category associated with the items of electronic content and the plurality of items of content; and
the user provides only a request to access the item of electronic content by selecting a displayed item upon an electronic device associated with the user.

3. The method according to claim 1, wherein
the generated on-demand item of content is generated in dependence upon the characteristics of a display of an electronic device associated with the user requesting the item of electronic content and the plurality of items of content for display.

4. The method according to claim 1, wherein
the electronic format of the generated on-demand item of electronic content is established in dependence upon a characteristic of a user interface upon an electronic device associated with the user with which the generated on-demand item of electronic content will be displayed to the user.

5. The method according to claim 1, wherein
the item of electronic content is generated in dependence upon a format associated with the item of electronic content and an electronic device associated with the user upon which the user makes the request to receive the item of electronic content.

6. The method according to claim 1, wherein
the plurality of items of content are established in dependence upon an asset table stored within a memory of a computer server, each entry in the asset table relating to a digital asset at least one of selected and bookmarked by the user through a user interface on a computer system.

7. The method according to claim 1, wherein each item of content of the plurality of items of content is established by applying a filter of a plurality of filters to elements accessible through a network by the user and selected by the user.

8. The method according to claim 1, wherein
the item of electronic content is generated in dependence upon a filter of a plurality of filters, the filter selected in dependence upon a content category associated with at least one of the items of electronic content and the plurality of items of content, the plurality of items of electronic content and a characteristic of an electronic device associated with the user requesting the item of electronic content.

9. The method according to claim 1, wherein
each item of content of the plurality of items of content was initially established by at least one applying a filter of a plurality of filters to a web page selected by the user and a selection associated with a web page made by the user.

10. The method according to claim 1, wherein
each item of content of the plurality of items of content is associated with an item forming a predetermined portion of an online purchase made by the user.

11. A method comprising:
establishing an asset table stored within a memory associated with a computer system, each entry in the asset table relating to a digital asset at least one of selected and bookmarked by the user through a user interface presenting data to the user;
accumulating for each digital asset within the asset table a content post, each content post generated by applying a predetermined process to the digital asset;
generating posted electronic content from a plurality of content posts, the plurality of content posts established in dependence upon the entries within the asset table; and
formatting for presentation to the user the posted electronic content.

12. The method according to claim 11, wherein
the posted electronic content is also established in dependence upon at least one of a format preference of the user, a characteristic of a display forming part of an electronic device associated with the user, and an intended application in execution upon the electronic device to present the posted electronic content to the user.

13. The method according to claim 11, wherein
formatting for presentation to the user the posted electronic content comprises applying a filter of a plurality of filters to the posted electronic content, wherein each filter is associated with at least one of a software application and a standard for publishing electronic content.

14. A method of generating a receipt for an online purchase comprising:
establishing an asset table stored within a memory associated with a computer system, each entry in the asset table relating to an asset purchased by the user as part of an online transaction, each entry in the asset table relating to a purchased asset and comprising a digital asset relating to the purchased asset and selected by the user through a user interface presenting data to the user when adding the purchased asset to a digital cart containing items selected for purchase;
accumulating for each digital asset within the asset table a content post, each content post generated by applying a predetermined process to the digital asset;
generating posted electronic content from a plurality of content posts and data relating to the completed asset purchase, the plurality of content posts established in dependence upon the entries within the asset table; and
formatting for presentation to the user the posted electronic content.
